(19) United States
(12) Patent Application Publication
(10) Pub. No.: US 2026/0244155 A1
(43) Pub. Date: Aug. 20, 2026

(54) MEASUREMENT METHOD FOR DETERMINING A REPLICATION PARAMETER, AND REPLICATION METHOD USING THE DETERMINED REPLICATION PARAMETER

(71) Applicant: CARL ZEISS JENA GMBH, Jena (DE)

(72) Inventors: Markus GIEHL, Jena (DE); Christian BLECHSCHMIDT, Jena (DE)

(21) Appl. No.: 19/160,766

(22) PCT Filed: Feb. 27, 2024
(86) PCT No.: PCT/EP2024/054918

§ 371 Date: Aug. 28, 2025

(30) Foreign Application Priority Data
Mar. 1, 2023 (DE) 10 2023 105 027.3

(51) Int. Cl. G03H 1/20; G03H 1/02; G03H 1/04

(52) U.S. Cl. CPC G03H 1/202; G03H 1/0248; G03H 1/0486; G03H 2222/12; G03H 2222/36; G03H 2223/14; G03H 2240/52; G03H 2240/53

(57) ABSTRACT

A measurement method for determining at least one replication parameter for a replication method using at least one master element involves providing a master element comprising a reflection hologram, a light source, a detector, and a diffuser. The diffuser is positioned between the master element and the detector. The measurement method also involves irradiating the master element with light from the light source, sensing an intensity distribution of the light exiting the diffuser using the detector, and determining at least one replication parameter on the basis of the sensed intensity distribution.

### DESCRIPTION

The invention relates to a measuring method for defining at least one replication parameter for a replication method using at least one master element. The measuring method comprises providing a master element comprising a reflection hologram, a light source, a detector and a diffuser. The diffuser is present positioned between the master element and the detector. The measuring method furthermore comprises irradiating the master element with light by means of the light source, capturing an intensity distribution of the light emerging from the diffuser by means of the detector, and defining at least one replication parameter on the basis of the captured intensity distribution. Furthermore, the invention relates to a replication method for the replication of a hologram from a master element into a light-sensitive material. The replication method is effected by way of applying at least one replication parameter which was defined by means of the measuring method according to the invention.

### BACKGROUND AND PRIOR ART

The invention relates to the field of replication of holograms.

HOEs (Holographic Optical Elements) typically denote optical components in which holographic properties are used to attain a specific beam path of the light, such as e.g. transmission, reflection, diffraction, scattering and/or deflection, etc. As a result, desired optical functionalities can be implemented in arbitrary substrates in a compact manner. The holographic properties preferably exploit the wave nature of light, in particular coherence and interference effects. Both the intensity and the phase of the light are taken into account here.

Such holographic elements find application in many fields, such as e.g. in transparent displays (e.g. in display windows, refrigeration equipment, vehicle windowpanes), for illumination applications, such as information or warning signals in glass surfaces, light-sensitive detection systems for example for interior monitoring (eye tracking in vehicles or presence status tracking of persons in interiors).

Holograms are generated by the interference of a reference beam with the light reflected or diffracted by the surface of an object (object beams). Three-dimensional objects have traditionally been used in order to produce unique, customized holograms. By contrast, commercially available HOEs are often produced by means of replication methods in mass production. Such replication methods generally use a master hologram having the image to be copied. Although the reproduced image is generally intended to correspond exactly to the image recorded in the master hologram, it may be desirable to introduce targeted deviations from the master hologram in the replication method. Such targeted deviations in the replicated image can be brought about in particular by adapting the exposure steps of the replication method. The master holograms used are often stored in a substrate body bearing the master hologram. The substrate body is preferably transparent and can have various shapes, for example a parallelepipedal shape, a plate or a roller. The combination of the master hologram with the substrate body forms a master element.

The master element is exposed using a coherent light source in order to replicate the image from the master hologram into a light-sensitive composite. For mass production, the light-sensitive composite can be provided in the form of a flowing web comprising a light-sensitive material and one or more carrier or protective layers. For this purpose, the light-sensitive web is preferably transported through various work stations in order to produce the HOEs.

During the exposure, the composite web is placed onto a surface of the master element. In order to generate a reflection hologram, the coherent light can traverse the composite web before it reaches the master hologram and is reflected by the latter back into the composite web. The object and reference beams interfere with one another in the light-sensitive material and form the replicated hologram. The replication process reacts sensitively to changes in the exposure angle, intensity, wavelength, etc., which have to be adapted according to the optical function of the master hologram. It is customary to carry out the exposure for each master hologram according to a series of preprogrammed parameters. These parameters are generally configured such that they generate a replicated hologram having exactly the same properties as the master hologram. If a targeted deviation from the properties of the master hologram is desirable in the replicated hologram, this deviation is generally calculated on the basis of the theoretical properties of the master hologram.

In order to ensure an error-free replication, it is necessary for the actual optical properties of the master hologram to correspond to the theoretical properties used for calculating the replication parameters. In practice, however, the master holograms may deviate from their target properties. This may lead to a mismatch between the exposure parameters and the master hologram, which leads to reproduction errors in the light-sensitive material.

In the course of the manufacture of the master hologram through to the replication thereof there are a series of process steps which can alter the optical function of the master originally produced. For example, shrinkage may accompany the polymerization of a photopolymer during the creation of the master hologram in local regions. Shrinkage of the light-sensitive material, e.g. as a result of partial drying and an increase in its density owing to the polymerization, can reduce the required wavelength for generating an interference pattern recorded therein. Further deviations of the properties of the master hologram may occur on account of temperature fluctuations in the manufacturing method or during the adhesive bonding or embedding of the master hologram into a master element. Degradation of the master element can likewise occur over the course of time and likewise alters the optical function.

Such changes in the properties of the master hologram cannot be reliably predicted by a simulation. Moreover, there is a lack of practicable methods for metrologically capturing the deviation of the optical function of the master hologram from a theoretical optical function.

By way of example, the use of an optical goniometer for analyzing the actual optical function of the master element could be considered. However, since the optical function- and its deviation from a target value-can vary spatially across the master element, a large number of measurements would have to be carried out in order to capture the change in the entire master hologram. This complex process would require the use of devices which analyze the master hologram piecewise over a long period of time and take up a large amount of space. Such an approach is therefore practicable only to a very limited extent. The necessary time expenditure becomes an even greater obstacle when it is taken into account that the function of a master element can also change over the course of time. The method therefore possibly needs to be repeated at regular time intervals in order to monitor and/or compensate for deviations in the optical function of the master element. In a continuous production process this is a particular impediment since interruptions in production and a reduction of the throughput occur as a result.

Therefore, there is a need for a method for analyzing the optical function of a master element, in particular for recognizing deviations from a target function, which can be carried out in a short time and is suitable for application in a continuous production installation. Furthermore, there is a need for a replication method in which possible errors in a master element can be reliably taken into account or compensated for.

### OBJECT OF THE INVENTION

It is an object of the invention to provide a measuring method which, using simple means, rapidly and reliably makes it possible to capture optical properties of a master element and in particular can establish possible deviations of the optical function of the master element from a target function. Furthermore, it was an object of the invention, by means of such a measuring method, to be able to define replication parameters which increase the efficiency of a replication method using the master element, in which case particularly preferably in addition the possibility should be afforded of compensating for possible deviations of the optical function of a master element from a target function in the replication method.

### SUMMARY OF THE INVENTION

The object is achieved by the features of the independent claims. Advantageous configurations of the invention are described in the dependent claims.

In a first aspect, the invention relates to a measuring method for defining at least one replication parameter for a replication method, the replication method being effected using a master element. The measuring method comprises the following steps:
providing a master element comprising a reflection hologram, a light source, a detector and a diffuser, the diffuser being present positioned between the master element and the detector,
irradiating the master element with light by means of the light source,
capturing an intensity distribution of the light emerging from the diffuser by means of the detector, and
defining at least one replication parameter on the basis of the captured intensity distribution.

Preferably, the master hologram is positioned in or on a substrate body in order to form a master element. Integrating a master hologram into a master element ensures high robustness. Since the master hologram is very thin and sensitive, integration into a larger component can facilitate handling and eliminate the need to touch the master hologram itself, which may lead to damage. However, the process steps for producing the master hologram and the integration thereof into a master element may influence the desired optical function.

Firstly, the method for producing the master hologram may lead to physical alterations of the light-sensitive material into which it is written. For example, the polymerization during the mastering process may lead to undesirable shrinkage of the light-system material, as a result of which the optical properties thereof change in an unwanted manner. Furthermore, uncontrolled light scattering may lead to additional exposed structures within the light-sensitive material and may reduce the efficiency of the desired interference pattern. Perfect regulation of the production conditions for a master hologram is usually not able to be realized, or able to be realized only with high expenditure. Therefore, the master hologram is generally produced within the bounds of specific manufacturing tolerances. In order to counteract the effects of undesirable shrinkage or undesirable interference patterns, it is advantageous to localize these and/or to quantify their effect.

Moreover, the process of integrating the master hologram into the substrate body in order to form the master element is susceptible to errors. A nonuniform distribution of an adhesive between the master hologram and the substrate body or a nonuniform surface structure between the master hologram and the substrate body may lead to nonuniformly distributed optical losses over the master element. Owing to the unforeseeable nature of such losses and their variable spatial distribution, it is not straightforwardly possible to quantify, simulate or estimate them. For reasons of economically viable realizability, the process of integrating the master hologram into a master element is likewise effected within defined manufacturing tolerances.

The present invention makes it possible to define replication parameters which are suitable for the actual properties of the master element, which preferably lie within the aforementioned manufacturing tolerances. A replication method can thus be made more robust with respect to the aforementioned tolerances.

Furthermore, the replication of the master hologram into a light-sensitive material can best be carried out by guiding the exposure light beam (or the exposure point) by way of a predetermined path coordinated with the optical function of the master hologram. In this regard, an efficiency of the master element for a replication process may be dependent on various parameters, such as an angle of incidence or a wavelength.

In an ideal master element with a reflective master hologram which is irradiated from an optimum exposure point or exposure path, an exposure beam is preferably almost completely diffracted into a 1st order. The exposure light beam (reference beam) can interfere with the reflected light beam (object beam) in an intervening light-sensitive material in order to copy the hologram. That portion of the exposure beam which is diffracted into the 1st order thus corresponds to a desired used wave which can serve for the replication of a hologram. That portion of the exposure beam which is not reflected or diffracted passes through the master hologram and the carrier substrate. In the case of an ideal master element, the portion of the transmitted 0 order of diffraction would be equal to zero and the entire portion of the exposure beam would be reflected. In the case of an ideal master element, therefore, no light at all should be transmitted through the master element to an opposite side.

However, if the master hologram has deformed in the course of integration into a master element, e.g. owing to the weight of the substrate body, a nonuniform adhesive layer or delamination effects, the theoretical exposure point optimized in regard to the ideal master element possibly does not allow a high efficiency over all of the regions of the master hologram. By way of example, shrinkages, nonuniform adhesive layers or delamination effects may have the consequence that specific regions of the master hologram would have to be irradiated from deviating exposure points or angles in order to generate a sufficient used wave.

The inventors' contribution is having recognized that an efficiency of the master hologram for a replication can be quantified and/or mapped by capturing light which emerges through a side of the master element facing the detector. For this purpose, a diffuser is present between the master element and the detector.

The master element preferably comprises a side facing the detector. This can be referred to here as “the first side of the master element” or “the side of the master element facing the detector”. This is preferably a side of the master element which is not exposed, but through which portions of the exposure light beam (in particular a 0 order of diffraction) can emerge.

A side of the master element on which a reference beam is incident in order to expose the master hologram is preferably referred to in the present case as “the second side of the master element” or “the side of the master element facing away from the detector”. This side is preferably substantially parallel to and opposite the first side of the master element. By way of example, an upper side of the master element is the first side and a lower side of the master element is the

A “diffuser” (or “diffusing plate”) within the meaning of the invention is preferably a transparent plate or film configured to scatter and/or expand a light beam as it passes through the plate or the film. The scattering is preferably effected with the aid of a roughened surface of the diffuser, pigment substances in the diffuser, a crystal structure of the diffuser and/or on account of opalescent properties of the diffuser. Preferably, the diffuser functions approximately like a Lambertian diffuser. In preferred embodiments, the diffuser can also be a surface-structured diffuser which was produced holographically. Preferably, the selected diffuser is not a volume-holographic diffuser, in order to avoid an angle selectivity.

In preferred embodiments, the diffuser can be applied directly on a first side of the master element, such that it is in direct contact with the latter. Direct contact is not a necessity, however. The contact can be mediated by a further layer such as an optical liquid or an optical incoupling element. Likewise, there can also be no contact between the diffuser and the master element, such that the diffuser is situated at a distance on the first side of the master element. In some preferred embodiments of the invention, provision can be made of a holding device for positioning the diffuser between the master element and the detector, the holding device defining for example a distance between a first (upper) side of the master element and a lower side of the diffuser. In the various embodiments, however, the diffuser is preferably always situated between the master element and the detector, the diffuser, in particular in the embodiment of a diffusing plate, preferably being present aligned parallel to the master element.

The positioning of a diffuser between the detector and the master element makes it possible to increase the capturability of the emerging light, whereby the measuring method becomes more reliable. In particular, the diffuser preferably ensures that the emerging light reaches the detector independently of an angle of emergence. Since the surface roughness of the diffuser has the effect that scattered light is transmitted by surfaces pointing in different directions, the emerging light can preferably be captured practically from any angle within a hemisphere. This is particularly useful if the detector is kept stationary but the measuring method is applied to different master elements or different exposure paths with varying illumination angles. An overly accurate positioning of the detector becomes superfluous as a result.

By capturing the light transmitted by the diffuser using a detector, it is possible to quantify the intensity (and optionally the wavelength) of the transmitted light. Therefore, the measuring method does not have to rely on the subjective assessment of the master element, and the expenditure for trial and error in order to compensate for deviations from a desired optical function or changes in the efficiency of the master element can be reduced and/or eliminated. Moreover, there is no need to take a subjective decision as to whether a master element is damaged so severely that it needs to be replaced. Instead, these decisions can be taken objectively on the basis of repeatable quantitative measurements.

Capturing an intensity distribution of the light transmitted by the diffuser makes it possible to objectively identify the regions affected by the deviation of the optical function of the master element or the reduction of the efficiency. The measured deviation or reduced efficiency of the master hologram in regard to a replication can thus be used for mathematically adapting a replication parameter. In this respect, for example, it is possible to increase the intensity of the exposure in those regions which have a high intensity of the transmitted light.

The increase in the intensity during the replication can preferably be adapted in such a way that the optical loss is exactly compensated for. This can be accomplished quickly and automatically by a processor, and so a repeated adaptation or a subjective evaluation of the result is not necessary. In particular by capturing the light intensity emerging from the first side of the master element as a two-dimensional spatial distribution, it is possible for the exposure light intensity also to be adapted in a spatially dependent manner. For example, the intensity values of different spatially distributed points on an exposure curve can be adapted independently of one another.

By quantifying the inefficiency of the master element by measuring the intensity of the emerging light, it is also possible to objectively evaluate whether an exposure point is not optimal and needs to be adapted. An adaptation of the exposure point preferably means an alteration of the position of the exposure point from which the reference beam is directed at the master element. The entire master element can be exposed over a large area from a single exposure point. In this case, the measuring method can preferably mediate the selection of the optimum position of the exposure point. Likewise, the master element can also be exposed from a plurality of exposure points, in particular from a series of spatially distributed exposure points on an exposure curve. Each of these spatially distributed exposure points can be assigned a respective region from a plurality of spatially distributed regions of the master element. In such a case, capturing the light intensity as a spatially resolved distribution can enable statements concerning the efficiency of the respective regions of the master element and ensure an adaptation of the exposure points depending on their assignment to the regions of the master element.

By evaluating the inefficiency of the master element on the basis of the intensity of the emerging light, it is also possible to establish whether the exposure angle is not optimal and needs to be adapted. This can mean that the angle at which the reference beam is incident on the master element is changed by a mathematical adaptation for the entire master element. However, since an intensity distribution is captured, rather than just an individual intensity value, the exposure angle can also be adapted for individual regions of the master element.

Likewise, it is advantageously possible to carry out the measuring method for different exposure paths in order to identify an optimum exposure path (also called “exposure curve” within the meaning of the invention) for which the efficiency of the master hologram is maximal. A later replication process can be carried out with a correspondingly optimized exposure path, corresponding regulation of the intensity optionally enabling possible efficiency losses to be precisely compensated for.

The measuring method can thus enable a replication process which is coordinated exactly with the actual (and not just theoretical) properties of a master element. The resulting holograms have a higher quality and can be produced highly reproducibly.

Arranging a diffuser between the master element and a detector that captures the light emerging from the diffuser enables a very compact design of the device for the measuring method. A diffuser comprising a plate or film, for example, occupies only little space in an exposure chamber. The diffuser can easily be introduced and removed with the aid of rollers, suction robots, manually or in some other way. Since the holograms that are replicated on the basis of the results from the measuring method are reflection holograms, the diffuser has no influence on the positioning of the light-sensitive material on the master element. The reason for this is that the light-sensitive material is positioned on the opposite (second) side of the master element. Rollers for laminating or applying light-sensitive material onto the master element can remain unchanged in their position, as also can devices for applying optical liquids, incoupling elements and the like. Moreover, a detector directed at the diffuser need not conflict with the devices used for the exposure, such as light sources, lens elements, mirrors, etc., since these can also be directed at the opposite side of the master element in order to replicate a reflection hologram.

The device required for the measuring method can thus easily be integrated into a device for continuous and/or automated replication of a reflection hologram. The measuring method can be carried out in a simple manner at intervals or between the passes of the replication process, without the replication devices having to be dismantled or rearranged. In this regard, wear or degradation of a master element can be monitored and/or replication parameters can be continuously adapted in order to compensate for alterations of the master element.

A “replication parameter” within the meaning of the invention is preferably a physical parameter that can be variably adjusted between the passes or between individual repetitions of a replication method for holograms. Preferably, the replication parameter is a physical parameter that relates to the exposure step of the replication method. In particular, the replication parameter is a physical property or a physical parameter that relates to the exposure light beam (which functions as reference beam). It can be advantageous for a replication parameter to relate to the exposure of the entire master element. This is the case in particular for replication methods in which the master element is exposed over a large area from a single exposure point. Likewise, it can also be advantageous for the replication parameter to be specific to a spatial region of the master element. This is relevant in particular to replication methods in which the master element is preferably exposed gradually by means of the movement of a light point on the master element step by step over a scanning process. In such a case, it is possible for example to adapt a replication parameter in relation to an intensity of the exposure for different light points on the master element.

The term “light point” preferably denotes a point on the master element at which the light beam is incident on the surface of the master element, while the exposure point preferably lies outside the master element and denotes a point from which a light beam for the exposure of the master element is incident on a surface of the master element without significant deflection.

The replication parameter can also be specific to a temporal segment of the exposure step.

The replication parameter can be for example a light intensity, a wavelength, a range or a selection of wavelengths, a coherence, a speed of movement of the exposure point, a residence time of the light point, an angle of the incident exposure light beam, an absolute, relative and/or angular position of the light source, an absolute, relative and/or angular position of a light deflection component such as a mirror, a prism, a lens element or an optical fibre. In preferred embodiments, the replication parameter can also relate to a sequence of exposure points, which is to be used in the form of an exposure curve for the exposure of the master element. Likewise, it goes without saying that a combination of the abovementioned replication parameters is conceivable and preferred in which for example replication parameters are defined for a plurality of anchor points of an exposure curve, different intensity values for the exposure of different regions of the master element being defined for each anchor point. “Defining a replication parameter” within the meaning of the invention preferably comprises estimating, calculating, selecting or ascertaining a replication parameter for which a higher efficiency of the master hologram arises or is expected. Preferably, defining the replication parameter involves ascertaining an optimum radiation dose (in particular radiation intensity and/or residence time) which attains a best possible exposure of a master hologram or of a region thereof into a light-sensitive material. The estimating, calculating, selecting or ascertaining can preferably be carried out by a data processing unit. The results of the estimating, calculating, selecting or ascertaining can preferably be stored in a storage unit. The defined replication parameters stored can preferably be used for a further process step. The storage unit can preferably be accessed by a control unit for controlling a replication method in order to read out the defined replication parameter and/or to transmit a signal to an actuator in order to expose the master element with the defined replication parameter.

A “detector” within the meaning of the invention is preferably one or more devices for measuring and/or acquiring data. Preferably, the detector is designed to convert an analogue and/or non-electrical input signal into an electrical and/or digital output signal. In this case, besides the light intensity, the detector can represent further physical variables (e.g. wavelength) as an electrical voltage, pulse and/or current intensity. The output signals preferably comprise information about an absolute or relative spatial distribution of the physical variables. The detector can comprise for example a camera, a scanner or an array of photodiodes. Preferably, the detector forwards the output signals to a processor, memory and/or a communication unit.

A “light source” within the meaning of the invention is preferably a device configured to emit electromagnetic radiation having a wavelength of between 200 nm-25 μm, in particular between 400-780 nm. The electromagnetic radiation can preferably comprise infrared, visible and/or ultraviolet radiation, with visible radiation being particularly preferred. In the context according to the invention, UV radiation preferably means electromagnetic radiation in the range of 200 μm to 400 μm, particularly preferably 300 μm to 400 μm. In particular, visible radiation means electromagnetic radiation in the range of 400-780 nm and infrared radiation means radiation in the range of 780 nm to 25 μm, preferably in the near infrared range, i.e. preferably of 780 mm to 3000 nm, in particular of 780 nm to 1400 nm.

The light source can comprise or be associated with light-deflecting devices such as lens elements. The light source can preferably emit a collimated beam, in particular having a specific width and direction. Likewise, it can be preferred for a beam emitted by the light source to have a desired divergence at an exposure point in a targeted manner. Preferably, the light source is also configured such that it emits coherent light. The light source can be a laser, for example.

Within the meaning of the invention, an “exposure point” is preferably a point from which a light beam for the exposure of the master hologram is incident on a surface of the master element without significant deflection. The exposure point can be the light source itself or can be situated on an element which directs the light from the light source, such as e.g. a mirror. By way of example, the exposure point could correspond to a focus point along the beam path, that is to say that the light can have a small beam cross-section at the focus point compared with downstream or upstream along the beam path. Alternatively or additionally, the exposure point could be coincident with the arrangement of a lens element or a mirror which implements a last beam deflection before the light is incident on the master element. A change in the exposure point preferably comprises a change in the position of this exposure point.

A “master element” is preferably a three-dimensional unit which comprises at least one master hologram in a form which ensures that a movement of the master element leads directly to a corresponding movement of the master hologram. A master element can also comprise a plurality of master holograms, for example 2, 3, 5, or more. Preferably, the master element has a length and a width which correspond at least to the length and width of the master hologram. It is preferred for the height of the master element to be at least double, preferably five times, and particularly preferably at least twenty times, the height of the master hologram.

The master element preferably comprises a substrate body, which either encloses or carries the at least one master hologram. In embodiments, the master element can comprise for example a transparent upper cover for protecting a master hologram present between the cover and the substrate body. Preferably, the upper cover is likewise transparent. The upper cover can be for example a transparent film or a glass layer.

The master element can preferably have the shape of a parallelepipedal block, a plate, a pyramid, or a prism. The substrate body can be shaped correspondingly.

With preference, the substrate body of the master elements can be formed from a material which is an optical plastic, preferably selected from the group: polymethyl methacrylate (PMMA), polycarbonate (PC), cycloolefin polymers (COP) and cycloolefin copolymers (COC), and/or is an optical glass, preferably selected from the group: borosilicate glass, quartz glass, B270, N-BK7, N-SF2, P-SF68, P-SK57Q1, P-SK58A and P-BK7.

Preferably, both the substrate body and a possible cover of the master element have a refractive index of between 1.4 and 1.6.

The selection of the material for the substrate body can depend on the desired exposure angle or refractive index. It can additionally be preferred for a substrate body to be coloured in order for example to wavelength-selectively filter light in order to generate a hologram with a specific wavelength. In this way, it is possible to use a broadband light source for the exposure of different master holograms.

It is preferred for the surface or cover of the master element to comprise glass, PC, TAC or PMMA. The material of the surface can be present in the form of a film or plate for protecting the master hologram. However, the material of the surface or of the cover can also be the material of the substrate body itself and have for example a parallelepipedal shape or cylindrical shape.

A “substrate body” within the meaning of the invention is preferably a three-dimensional material block that carries or encloses the master hologram. Preferably, the substrate body is transparent. In some embodiments, the substrate body has a plurality of surfaces, including a planar surface that can be oriented horizontally. In some embodiments, the substrate body is prismatic, that is to say that it has a constant cross-section of arbitrary shape, e.g. square, polygonal.

Within the meaning of the invention, the term “transparent” or “transparency” preferably relates to a property of a material whereby it is substantially transmissive to light. Preferably, a transparent material within the meaning of the invention is transmissive at least to part of the electromagnetic spectrum, preferably with a wavelength of between 200 nm-25 μm, particularly preferably between 400 nm-780 nm. Particularly preferably, a transparent material, for example a transparent substrate body, is transmissive to light in a wavelength range with which an exposure of the master hologram is effected. A transparent material can also be coloured in such a way that it selects the light radiation of one or more specific wavelength(s).

A “master hologram” within the meaning of the invention is preferably a holographic optical element comprising at least one hologram to be replicated. The master hologram is designed for an optical function (e.g. diffraction, reflection, transmission and/or refraction) for one or a plurality of wavelengths. The master hologram can be a diffractive optical element (DOE), for example. Diffractive optical elements (DOEs) use a surface relief profile with a microstructure for their optical function. Alternatively, the infrastructure can also be present in the volume of the element, e.g. in the form of a local difference in refractive index. Such a master hologram is deemed to be a so-called “volume hologram”. The light transmitted by a DOE can be converted into almost any desired distribution by diffraction and subsequent propagation. This can involve an image, a logo, a text, an interference pattern or the like.

The process for producing the master hologram can preferably be referred to as “hologram origination” or “hologram mastering”. The master hologram can be created by an analogue or a digital method. In one exemplary analogue method, a first coherent beam, the object beam, is reflected from an object onto a recording material, which is simultaneously subjected to a second coherent beam, the reference beam. The object beam and the reference beam interfere and generate an interference pattern on or in the recording material. This interference pattern is recorded by light-sensitive material, and so after processing this gives rise to the shape of a surface relief pattern on a surface of the material or a spatially varying refractive index in the material, which is usually only a few micrometres thick. In order to view an image of the original object, the master hologram can be illuminated with light that is diffracted by the recorded surface relief pattern or refractive index pattern. This diffracted beam contains the image of the original object. The master hologram can subsequently be used as a new object when creating further copies with the same image.

The master hologram can preferably also be computer-generated. The microscopic gratings which generate the diffraction effects can be produced e.g. by laser interference lithography. In this technique, two or more coherent light beams are configured such that they interfere at the surface of a recording material. The positions of the light beams with respect to the recording material can be controlled by a computer. Depending on the intensity of the laser, the recording material can consist of almost any material. Other techniques such as electron beam lithography can likewise be used for the digital production of the master hologram. The master hologram can preferably comprise glass, silicon, quartz, UV lacquer, a photopolymer composite and/or a metal such as nickel.

In one preferred embodiment of the invention, higher values of the intensity distribution indicate a lower efficiency of the master element in a replication method. Preferably, the light scattered by the diffuser corresponds to a zero (0) order of diffraction of an exposure beam, which light is transmitted through the master hologram and cannot be used for replication. The higher the proportion of the (undesired) 0 order of diffraction, the lower the proportion of the 1st order of diffraction, this proportion being used as object beam for replication. Higher values of the intensity distribution at the detector thus indicate a higher proportion of a 0 order of diffraction and hence a lower efficiency of the master element.

In other words, the light detected at the detector preferably corresponds to that light which is transmitted by the interference pattern of the master hologram, without being diffracted by the interference pattern of the master hologram. Since the angle and the position of the exposure beam are chosen such that the latter is directed into a 1st order of diffraction by the theoretical interference pattern in the master hologram, in the case of an ideal master hologram the entire incident light should be reflected and thus form an object beam. This applies in particular to an ideal master hologram which is designed to completely reflect the incident light. In an ideal case for such a master hologram, the proportion of a 0 order of diffraction would be equal to zero and the detector would not capture any light emergence from the diffuser. If light emergence from the diffuser is recognized, however, this indicates that the efficiency of the master element is reduced at the point at which the light leaves the master element. Reflection master holograms can however likewise be configured on the basis of practical limitations or with regard to specific applications to the effect that they reflect only a proportion of the incident light even in the best possible case. In this case, the proportion of a 0 order of diffraction is not zero even in the best possible case, but rather corresponds to a known theoretical target intensity that is not equal to 0. If the detected intensity exceeds such a target intensity, this likewise preferably indicates a lower efficiency of the master hologram at the point at which the target intensity of the transmitted 0 order of diffraction is exceeded.

The greater the captured light intensity, the lower the local efficiency of the master element. It may be, for example, that the master element has undergone shrinkage at this location, as a result of which the thickness of the master hologram has decreased. This can reduce the reflection efficiency. It is preferably the extent and the distribution of this reduction of the reflection efficiency which the intensity distribution indirectly captures.

Within the meaning of the invention, an “efficiency” of a point or of a region of a master hologram (the local efficiency) is preferably the ability of the master hologram at this point or region to implement a desired light directing function without losses. The local efficiency of the master hologram can be for example a measure of the intensity of the real object beam (or of the used wave) in comparison with the intensity of an ideal object beam (or of the used wave). In the case of an ideal master hologram which is designed for the complete reflection of the reference beam, the intensity of the ideal object beam preferably corresponds to the intensity of the reference beam, taking into account the Beer-Lambert law. Likewise, as explained above, even in the best possible case the reflection hologram may be designed to reflect only a proportion of the incident light. In this case, the intensity of an ideal object beam corresponds just to a proportion of the intensity of the reference beam. A target intensity of a theoretical 1st order diffracted beam can thus correspond to an intensity of the reference beam taking into account the Beer-Lambert law or just to a proportion (factor of less than 1). The local efficiency of the master hologram can preferably be calculated by dividing the intensity of the 1st order diffracted beam by the target intensity of a theoretical 1st order diffracted beam. The intensity of the actual 1st order diffracted beam can be calculated by subtracting the intensity of the detected zero order beam emerging from the diffuser from the intensity of the reference beam.

In these calculations, the distances traversed by the beams can be taken into account using the Beer-Lambert law. The local efficiency can be specified as a percentage, for example. This efficiency can vary spatially over the master hologram and can also depend on the physical properties of the reference beam. In particular, the efficiency of the master hologram can depend on the value of a replication parameter.

Within the meaning of the invention, the “efficiency” of the entire master hologram is preferably an assessment of the master hologram's ability to produce a replicated hologram with the desired quality. The efficiency of the master hologram as a whole can be a function of the local efficiencies over the entire master hologram. However, it can also depend on the intensity distribution and/or the spatial distribution of the local efficiencies. In this regard, e.g. the position and the surface area of inefficient regions can play a part in determining the efficiency of the master hologram. Such a determination can be carried out by a program on a data processing unit, for example an image processing algorithm, as known from the field of quality control.

The relationship between the captured light intensity and the efficiency of the master element can be used to select the optimum replication parameter, for example a light intensity of the exposure. A computer program can be used to calculate optimized exposure parameters from the efficiency values of the master element. Preferably, the calculation is carried out by a data processing unit. Such a data processing unit can be part of a control unit for controlling a replication method.

Preferably, defining the replication parameter is effected with regard to maximizing the efficiency of the master element in a replication method or with regard to reducing the deviation of the efficiency from a target value. In this way, the result of the measuring method can be used to optimize the replication and to ensure a high quality of the replicated holograms. In addition, as a result of an adaptation of the replication parameters for optimizing the efficiency, master elements, despite possible impairment, can advantageously continue to be used for a significantly longer time without severe quality losses. This increases the economic viability of the method.

In a further preferred embodiment of the invention, irradiating the master element with light is performed using at least two different exposure parameters. Preferably, the intensity distribution of the light emerging from the diffuser is captured for each of the at least two exposure parameters. By carrying out the measuring method for at least two different replication parameters, it is possible to examine the effect of varying the replication parameter on the efficiency of the master element. In this regard, it is possible to determine in what direction (e.g. increasing, reducing) a replication parameter can be corrected in order to improve the efficiency of the replication.

Preferably, defining the at least one replication parameter is effected on the basis of at least two intensity distributions which were captured for the at least two different exposure parameters. The multiple capture of intensity distributions for different exposure parameters can support the conclusion, for example, that shifting the exposure light beam in a specific direction, adapting the angle of the exposure light beam in a specific direction or increasing/reducing the wavelength of the exposure light beam increases an efficiency of the master element in a subsequent replication process. This information can be used to correspondingly adapt a replication parameter (for example in the direction identified as more expedient) in order to achieve an optimum replication.

By recording a plurality of intensity distributions, it can additionally be possible to compare the latter in order to ascertain an intensity distribution (or the exposure parameters on which the latter is based) which indicates a highest efficiency of the master element in the replication process. This can be for example an intensity distribution having the largest dark total area, an intensity distribution with the lowest total illuminance, or the intensity distribution for which bright regions (i.e. regions with a lower efficiency) correspond to regions of the master hologram which are categorized as the least critical (e.g. decorative regions in a hologram comprising text and decorative elements). On this basis, the replication parameter or a combination of replication parameters that results in the most efficient intensity distribution being achieved can be identified as more expedient for the replication. These replication parameters can be selected for use in a replication method or can be used for interpolation or extrapolation to a more expedient replication parameter. The quality of the replicated holograms can be further improved and a period of use of the master element without quality losses can be lengthened.

The proposed measuring method advantageously provides a significantly faster and more reliable technique for improving a replication efficiency and compensating for defects in the master element, compared with methods known from the prior art. In particular, measuring the influence of a plurality of possible exposure parameters on the efficiency of the replication in this way is more reliable than relying on the simulation of the optical function of the master element. The time-consuming analysis of a multiplicity of points on the master elements using a goniometer is also rendered superfluous by the measuring method.

In a further preferred embodiment of the invention, the at least one replication parameter corresponds to an exposure intensity, a wavelength, an exposure point, an angle of the beam path of the light at the exposure point and/or an exposure curve of the exposure point.

On the basis of the proposed measuring method, it is possible to optimize preferably one, a plurality or all of the abovementioned parameters for the replication of the master element.

By way of example, defining an exposure intensity as replication parameter makes it possible to compensate for possible optical losses or reductions in efficiency of the master hologram in a simple and precise manner in the replication process. In this regard, for example, the exposure intensity can be locally increased or decreased depending on a local efficiency of the master element. If the measuring method has established a reduced efficiency for specific regions on the master element, this reduced efficiency can be compensated for by a preferably proportional increase in the intensity of the exposure during a replication for those regions. Advantageously, deviations from an ideal master hologram are compensated for and an error-reduced, homogeneous replication of the master hologram is achieved.

Furthermore, the measuring method can advantageously define a wavelength as a replication parameter for a subsequent replication method. In this regard, it is known that shrinkage of master holograms can lead to a reduction of the wavelength of the interference pattern which is written therein and for which an efficient reflection is effected by the master hologram. In such a case, it is possible to diffract a reference beam with a theoretical target wavelength only with reduced efficiency. The proportion of transmitted radiation which cannot be used for the replication process is increased. In the measuring method, this is established by virtue of an increased intensity at the detector that captures the light scattered by the diffuser.

If the measuring method is carried out for example with different wavelengths as exposure parameter, an optimum wavelength can be defined (selected or interpolated) as replication parameter for a subsequent replication. As explained above, defining an optimum replication parameter can be effected for example on the basis of a minimization of the intensity captured at the detector in relation to the wavelength. In preferred embodiments, it is possible to define an optimized wavelength for the entire region of the master hologram or different wavelengths for different regions.

If the replication parameter identified by the measuring method is a wavelength of the exposure light, the wavelength of the reference beam can thus be brought closer to that wavelength for which the interference pattern in the master hologram is optimally designed. Additionally or alternatively, the exposure of the master hologram can be effected repeatedly with the target wavelength or with one or more improved wavelengths in order to increase the efficiency of the replication. The resulting outcome is replicated holograms of a significantly higher quality

The measuring method can identify a multidimensional parameter space within which an ideal parameter combination is intended to be selected as a compromise. Such a parameter space can relate to correlations between wavelength, angle and efficiency, for example.

Furthermore, it is known that the efficiency in particular of reflective master holograms can depend on the angle of incidence of a replication beam. Advantageously, the proposed measuring method can additionally be used to define an angle of the beam path of the light at the exposure point for a replication. The angle in the beam path of the light at the exposure point preferably determines the angle at which the master hologram is illuminated during the replication. Depending on the configuration of a master hologram, for different regions, too, there can be different angles which have an increased efficiency. With knowledge of the optical function of the master hologram, it would be possible, in principle, to simulate an angular distribution for the replication of a master hologram with optimized efficiency. Firstly, however, this is complex and, secondly, possible manufacturing tolerances can be captured only with difficulty.

Advantageously, the measuring method according to the invention allows an efficiency-angle map to be created rapidly using simple means, which map captures the efficiency of the master element as a function of different angles of incidence. It is thereby possible in particular advantageously to adjust an angle of the beam path of the light for an exposure during the replication in such a way that the reference beam is incident on the master hologram at a required angle in all regions during the replication.

Even possible deformations of the master hologram can be reliably captured by means of the measuring method and taken into account for a subsequent replication. By way of example, shrinkage or swelling of the master hologram can lead to locally different requirements in respect of an exposure angle. In the measuring method, the reduced efficiency as a function of the irradiation angle is captured as an increase in intensity at the detector. Optimizing the angle for a replication can thus be effected for example with regard to minimizing the intensity of the scattered light captured at the detector.

The efficiency of the replication method can additionally be improved by ascertaining a more efficient exposure point on the basis of the measuring method.

In a further preferred embodiment of the invention, the at least one exposure parameter is an exposure point. Preferably, capturing an intensity distribution of the light emerging from the diffuser is effected for at least two different exposure points.

By capturing at least two intensity distributions at at least two exposure points, the measuring method can experimentally ascertain which of the at least two exposure points yields the better results. In particular, it is possible to establish which of the tested exposure points leads to a lower illuminance of the diffuser. On this basis, it is possible to select a preferred exposure point for a replication method. The exposure point can be the position of a point for a large-area exposure or a regional exposure of a master element. A further exposure point can also be selected on the basis of the measured intensity distributions, for example by interpolation between two tested exposure points.

In a further preferred embodiment of the invention, capturing an intensity distribution of the light emerging from the diffuser is repeated for at least three exposure points. Preferably, the third and further exposure points are selected by a convergent function, in particular by an iterative process on the basis of the already captured intensity distributions, in order preferably to converge to an exposure point at which a maximum efficiency of the master element for a replication method should be expected. Alternatively or additionally, the third and/or further exposure points can be selected by a recursive process.

By capturing the intensity distribution for at least three exposure points, it is possible for the replication parameter to be selected on the basis of a larger number of test results and thus to approximate to an exposure point with the highest possible efficiency for a specific master element.

It can be preferred to capture at least four, at least five, at least ten, at least twenty or more intensity distributions in conjunction with a corresponding number of exposure points. The accuracy with which the replication parameters are ascertained can thereby be increased further.

By selecting the exposure points by means of a convergent function, the measuring method can be optimized such that the measurements carried out are restricted to the positions of the exposure points which are likely to yield the best results. An optimum exposure point can be selected more rapidly and more reliably than in a measuring method in which all the tested exposure points are defined in advance or not selected by means of a convergent function.

Within the meaning of the invention, a “convergent function” for selecting a parameter value is preferably a mathematical or algorithmic process which is based on refining an estimated variable until the latter is sufficiently accurate according to defined limits or converges toward an optimum. The convergent function can be based on an iterative or recursive algorithm, for example.

In a similar manner, a convergent function can be used to optimize a different replication parameter than an exposure point, such as e.g. a wavelength or radiation intensity. Preferably, the convergent function is used analogously to ascertain the value of the replication parameter for which a maximum efficiency of the master element for a replication method should be expected.

A first and/or a second replication parameter value can be selected in light of the target replication parameter, for example. The first and second replication parameters can also be selected according to the random principle, on the basis of maximum/minimum values from the manufacturing tolerances or according to some other formula. From the intensity distributions captured for the first and second replication parameters, an efficiency trend can be derived and used for selecting a third replication parameter. Selecting further replication parameters and capturing corresponding intensity distributions can be repeated until a specific number of parameter values has been tested, until the difference between the efficiencies of successive tested parameter values becomes less than a predefined value or if no further increase in efficiency is captured. Preferably, the replication parameter is an exposure point. It can also be preferred for the replication parameter to be a wavelength, an angle, a distance or an intensity.

A master hologram can be configured such that different locations are to be exposed with different replication parameters. For example, it may be necessary for some regions of the master hologram to be exposed with a higher or lower intensity, a predetermined angle of the reference beam or a predetermined wavelength. This can be achieved by scanning the master element with an exposure beam. During scanning, a light point is preferably moved along straight lines. So that regional variations of the replication parameters are attained, the exposure point can moreover also preferably be moved over a nonlinear path, e.g. a curve. In this case, it is possible to attain variations in the intensity by adjusting the intensity of the light source. Variations of the angle can be attained by tilting a light source or an optical intermediate component in order to generate a reference beam with the desired angle. A wavelength can be adapted for example by switching on one or more lasers or by applying filters. The path of the exposure point and the variable parameters can be provided as instructions in a memory.

In one preferred embodiment of the invention, the master element is designed for an exposure by way of an exposure curve. Preferably, the exposure curve defines the path of the exposure point for the replication of the master element. Further replication parameters besides the position can vary at different points or sections of the exposure curve. Preferably, the exposure angle varies over the exposure curve.

In the event of a master element being exposed with an exposure curve, the master element is preferably exposed regionally. The master element can be subdivided in columns, for example, each column being assigned a section of the exposure curve—in particular an anchor point. Likewise, the master element can be subdivided in a grating, each cell of the grating being allocated a section of the exposure curve—in particular an anchor point. Other configurations, such as e.g. freeform curves, can likewise be advantageous.

Use of an exposure curve can preferably enable a variable angle of incidence of the reference beam on the master element during an exposure. In particular, it is possible to vary the angle of incidence of the light as a function of the location of a corresponding light point of the light on the master element. This can be made possible by means of a suitable curvature of the exposure curve. It is thereby possible to achieve compensation of a curvature of the master element during the measuring or replication method, which curvature is predefined on the basis of the process for producing said element and deviates from the desired surface shape of a replicated hologram. To put it another way, therefore, a curved exposure curve can compensate for a curvature of the substrate or of the cover of the master hologram during the exposure process (this curvature being defined e.g. in relation to a reference coordinate system defined by the shape of the substrate).

Such an exposure curve is particularly advantageous if the replicated hologram itself is curved or is intended to be integrated into a curved surface. One example is a hologram with an optical function configured such that it converges light beams to a specific point. A further example is a hologram which is intended to be integrated into a curved transparent screen, a windshield or some other non-planar surface.

It can be advantageous for the exposure curve to comprise a plurality of anchor points. The measuring method can be used for defining a replication parameter at one or more anchor points. The exposure curve and/or the program for calculating same can be calculated so as to take account of a two- or three-dimensional space around the anchor point within which its position can be defined. The two- or three-dimensional space can preferably be a square or a parallelepiped and can be referred to here as exposure volume. The measuring method can preferably be used to determine the optimum position (or “exposure point”) of an anchor point within the exposure volume. In this way, the exposure curve can be adapted without the need for a totally new curve to be calculated anew.

An “exposure curve” within the meaning of the invention is preferably a path along which an exposure point is moved in order to expose a master element. Although the path can be linear, it is preferably curved in at least one plane. Preferably, the exposure curve connects a limited number of spatially distributed anchor points whose absolute positions or relative positions with respect to the master element are defined beforehand. Preferably, each anchor point is assigned a partial region of the master element. The exposure curve is preferably based on a mathematical function, in particular a nonlinear function, progressing through these anchor points. One or more exposure curves can be provided for a master element. Preferably, the positions of the anchor points and/or the mathematical function of the curve connecting them are/is provided in a memory that can be accessed by a control unit.

In a further preferred embodiment of the measuring method, capturing an intensity distribution is effected for a multiplicity of spatially distributed anchor points of an exposure curve, defining the at least one replication parameter relating to a shift of the exposure curve and/or a variation of the anchor points.

By capturing the intensity distribution of the light emerging from the diffuser at different anchor points of the exposure curve, it is possible for local inefficiencies of the master element to be compensated for independently of one another. If the replication parameters of an anchor point of the exposure curve are adapted, the exposure curve can offer a smooth transition to the further anchor points, the replication parameters of which were possibly not adapted, or adapted in a different way. The efficiency of the master element or of a subsequent replication can be increased. At the same time, the replicated holograms can have a high quality overall, with a seamless transition between regions which were exposed with different parameters.

Advantageously, in this embodiment, defining the at least one replication parameter relates to a shift of the exposure curve and/or a variation of the anchor points.

The intensity distributions may indicate that the master element has a uniformly distributed inefficiency, which requires a uniform increase in the exposure intensity. This may be the case if the total illuminances of all the recorded intensity distributions are approximately equal. By way of example, the recorded intensity distributions may differ by less than a predefined absolute value. A replication parameter can be adapted uniformly for the exposure curve, like a uniform increase in the exposure intensity, for example. The exposure curve can also be adapted uniformly to the actual optical function of the master element, for example by its being brought closer to the master element. As a result, the intensity of the exposure is increased and—depending on the embodiment—an exposure angle is adapted. The entire exposure curve can also be shifted in the plane parallel to the master hologram (horizontally) in order to bring the replication parameters closer to the actual optical function of the master element.

The intensity distributions can also indicate a total shift of the wavelength written in the master hologram (e.g. as a result of shrinkage or swelling of the entire master hologram), a tilting of the master hologram or a deviation of a further parameter, the deviation extending uniformly over the entire master hologram. It can be preferred to uniformly alter the corresponding replication parameter over the entire exposure curve, e.g. to increase/decrease the wavelength by a corresponding value or to tilt the entire exposure curve through a specific angle.

By virtue of shifting a replication parameter for the entire exposure curve, the fine tuning in the creation of the exposure curve, in particular the positions of the anchor points with respect to one another and the relative values of their replication parameters, can continue to be used. The total efficiency of a subsequent replication can be improved in a simple manner, without the need for the entire exposure curve to be calculated anew.

Alternatively, the intensity distributions at the different anchor points for which they were measured may indicate different efficiencies. This can lead to a replication parameter being defined for one anchor point independently of the others, in order to improve the efficiency of the master hologram during exposure from the anchor point. For example, the position of the anchor point can be changed and the exposure curve can be correspondingly adapted in order to provide a smooth transition to the adjacent anchor points. Preferably, a new position of the anchor point is selected from an exposure volume. Additionally or alternatively, a different replication parameter can also be defined for the anchor point. Instead of the position, this can be for example an intensity, an exposure angle or a wavelength.

In one preferred embodiment of the invention, the irradiation of the master element is controlled with the aid of a control unit. The control unit can determine and/or monitor the parameters used to carry out the measuring method or replication method. By way of example, the control unit can be configured such that it determines the intensity, the wavelength or the angle of a light beam and/or the exposure point used for carrying out the measuring method or replication method. Preferably, the control unit has access to a storage unit on which these and other relevant parameters are recorded. Preferably, the control unit is configured such that it links the ascertained intensity distribution with one or more exposure parameters used to carry out the measuring method. For example, a recorded intensity distribution can be linked with a specific position of the exposure point, for example an x-y-z-coordinate position. Preferably, the stored data can be retrieved via an output unit and/or be used for fixing the replication parameters.

In this sense, the measuring method can yield intensity distributions that are specific to a certain exposure parameter or a certain combination of exposure parameters. It is thereby possible to investigate the influence of the exposure parameter on the efficiency of the master element. Moreover, an optimized replication parameter can be defined on the basis of the exposure parameters for which the best intensity distribution was recorded.

It can also be preferred for the control unit to calculate indications concerning the exposure curve for the exposure of the master hologram or to retrieve them from a memory. For example, the control unit can calculate or retrieve the positions of a multiplicity of anchor points on the exposure curve and/or a mathematical function connecting the anchor points. The control unit can also be configured to give a signal to one or more actuators, such that the exposure point is moved along the exposure curve. The actuators can preferably comprise one or more motors, in particular one or more adjustment tables and/or one or more rotary drives. The actuators can preferably be part of a positioning module.

The speed of the movement of the exposure point can be preprogrammed, the control unit preferably being configured to move the exposure point at the preprogrammed speed along the exposure curve. Preferably, the control unit can also calculate or retrieve the replication parameters which are intended to be used at each anchor point. The control unit can also calculate or retrieve the replication parameters to be used between the anchor points, in which case these parameters can be determined in accordance with a mathematical function, for example by interpolation.

Within the meaning of the invention, the term “control unit” preferably denotes an arbitrary computing unit comprising a processor, a processor chip, a microprocessor or a microcontroller, which unit enables automatic control of the components of the method, such as e.g. the intensity of the light source, the position of the exposure point, the exposure angle, and/or possible actuators for adjusting the exposure parameters. The components of the control unit can be configured conventionally or individually for the respective implementation. Preferably, the control unit comprises a processor, a memory and a computer code (software/firmware) for controlling the components of the device.

The control unit can also comprise a programmable printed circuit board, a microcontroller, a programmable logic controller (PLC) or some other device for receiving and processing data signals from the components of the device, e.g. from sensors in relation to the exposure parameters currently used.

The control unit preferably comprises a computer-usable or computer-readable medium, such as a hard disk, a random access memory (RAM), a read only memory (ROM), a flash memory, etc., on which computer software or a code is installed. The computer code or the software for controlling the components of the device can be written in any desired programming language or model-based development environment, such as e.g. C/C++, C#, Objective-C, Java, Basic/VisualBasic, MATLAB, Python, Simulink, StateFlow, Lab View or assembler, without being restricted thereto.

The software and all functional descriptions of the software by the description of the control of specific components or aspects of the methods described herein are deemed to be technical features on account of a direct physical output to the devices used. Functional descriptions of software can therefore be regarded as preferred and defining embodiments of the invention.

The term “control unit is configured to” carry out a specific work step, such as e.g. determine the position of the exposure point, can comprise customized or standard software which is installed on the control unit and which initiates and regulates these operational steps.

The control unit is preferably configured such that it adapts one or more exposure parameters during the measuring method. For example, the control unit can be configured such that it switches a light source on or off. The control unit can additionally be configured such that it adjusts a brightness value, the wavelength, the position, the inclination, the direction and/or the speed of the movement of the light source. The control unit can additionally be configured such that it adjusts an exposure parameter by moving the positioning module.

The positioning module can preferably comprise or bear one or more light-directing components such as a lens element, a prism, a fibre or a mirror. The control unit can control the position, the inclination and/or the speed of the movement of one or more light-directing components. The control unit can control for example the coordinate position and/or the three-dimensional inclination of a scanning mirror. In this way, the orientation of the light from the light source can also be controlled, whereby the angle of incidence of the exposure beam on the master element is determined. The control unit can additionally be configured such that it controls the speed of the movement of one of the components mentioned above. A change in the speed can compensate for inefficiencies of the master element. The control unit can additionally be configured such that it controls the operation of the detector, e.g. the focus or the shutter time. The control unit can be configured such that it processes the data of the detector with the aid of a data processing unit, for example in order to compensate for an inclination of the detector relative to the first side of the master element. The control unit can furthermore be configured such that it evaluates the data of the detector, e.g. in order to assess the efficiency of a master element as acceptable or unacceptable, in order to select a parameter for a further measuring method or in order to define an optimized replication parameter.

In a further preferred embodiment of the invention, a control pattern for the intensity distribution is provided. This preferably involves capturing an intensity distribution for an isolated diffuser without a master element. That preferably means that the effect of the diffuser itself on the intensity distribution is captured. The control pattern is preferably taken into account when ascertaining the at least one replication parameter on the basis of the captured intensity distribution.

Within the meaning of the invention, an isolated diffuser is preferably a diffuser that is not used in combination with a master element. Preferably, the diffuser is the sole component between the diffuser and the detector if a control pattern is captured.

Capturing the intensity distribution of the diffuser itself when the latter is exposed by a light source results in a control value of the intensity for each point and/or region of the master element. The intensity distribution captured with the master element can be compared with the intensity distribution of the diffuser itself. Possible intensity losses caused by the diffuser can be taken into account here, such that the measuring method ascertains an optimum replication parameter on the basis of the actual properties of the master element. In this regard, it may be, for example, that the material of the diffuser absorbs light of a specific wavelength and thus influences the wavelength range captured by the detector. Quantifying the influence of the diffuser makes it possible to avoid the mistaken conclusion that the master element has successfully reflected the light absorbed by the diffuser. The replication parameters can thus be ascertained more accurately in order to improve the efficiency of the replication method. Likewise, local different scattering angles or transmission properties can occur in the diffuser and influence the measured intensity distribution at the detector. Acquiring a control pattern advantageously makes it possible to take account of such influences of the diffuser on the measured intensity distribution.

In a further preferred embodiment of the invention, the diffuser is a transmissive diffuser, which preferably behaves substantially like a Lambertian emitter.

A “Lambertian emitter” (or “Lambert emitter”) is preferably a light emitting body in which the radiation intensity of the light scattered in the direction of an observer (or a detector) is independent of the observation direction. A Lambertian diffuser preferably appears equally bright from all directions in the hemisphere from which the irradiation light emerges.

It can be preferred for the diffuser to function approximately like a Lambertian emitter. A maximum difference between the radiation intensity able to be established from a specific point on the diffuser from two arbitrary angles of a hemisphere is with preference not more than 50%, even more preferably not more than 30%, even more preferably not more than 10%. Providing a diffuser which functions substantially or approximately like a Lambertian emitter makes it possible to reduce the sensitivity of the measuring method vis-à-vis a position of the detector. It is particularly advantageous for the detector to capture the light intensity emerging from the diffuser almost with the same sensitivity, independently of its angle with respect to different locations of the diffuser. In this regard, it is possible to use a single detector with large diffusers and/or master elements. The reliability of the measuring method is increased.

Preferably, a deviation of the diffuser from a Lambertian target function is ascertained by capturing one or more control patterns. In this way, in particular, the influence of the capture angle on the intensity distribution can be quantified. It may be, for example, that if only a single, centrally positioned camera is used to capture the intensity distribution of a master element, peripheral regions of the master element appear darker on account of their non-orthogonal angle with respect to the camera lens. This effect is preferably quantified and taken into account in the evaluation of the recorded light intensities.

In one preferred embodiment of the invention, the diffuser has a rough surface facing the detector. With preference, the surface of the diffuser facing the detector has a surface roughness Ra of 0.1-100 μm, particularly preferably 1-10 μm. It has been established that for these roughnesses the diffuser acts substantially like a Lambertian emitter and at the same time yields a sufficiently precise intensity distribution.

The surface roughness Ra within the meaning of the invention is preferably the average of the profile height deviations from a mean line of the height of a surface.

The diffuser is preferably transparent to all wavelengths between 400-780 nm, in particular between 200 nm-25 μm. Preferably, all wavelengths in the visible spectrum, in particular between 400-780 nm, are transmitted equally by the diffuser. If specific wavelengths are absorbed by the material of the diffuser, then they are preferably taken into account in the interpretation, further processing or use of the captured intensity distributions. This can be done with the aid of a control pattern, representing an intensity distribution of the diffuser without the master element.

The width and length of the diffuser are preferably at least equal in magnitude to the width and length of the master element. The diffuser preferably has a thickness that is significantly smaller than its width and length. The thickness of the diffuser is with preference not more than 50 mm, more preferably not more than 20 mm, not more than 10 mm, not more than 5 mm or not more than 2 mm. With preference, the diffuser is in the form of a film. Providing a diffuser having one of the preferred thicknesses enables the diffuser to be kept so thin that an intensity distribution is clearly recognizable and precise conclusions are possible regarding the corresponding regions of the master element that transmit the captured light. A homogenizing effect of the diffuser can be kept small, such that meaningful intensity distribution patterns can be captured.

In a further preferred embodiment of the invention, the detector is a camera, which preferably captures the intensity distribution as a two-dimensional image representation of the surface of the diffuser. Advantageously, a camera can rapidly translate the intensity distribution into a digital image, which can be stored and/or input into a processor in order to calculate an optimized replication parameter. Moreover, cameras with high resolution, small dimensions and low weight are available. A compact camera with low weight can be moved synchronously with a scanning exposure point in order to generate images of the intensity distributions of diffusers/master elements of arbitrary size. In this case, small actuators can be used and the energy consumption of the method can be kept low.

Alternatively, partial regions of the diffuser can also be illuminated successively, such that the camera captures the intensity distribution of the individual partial regions. A processor can then combine the intensity distributions in order to reconstruct the intensity distribution over the entire diffuser. This embodiment can be used for example to capture intensity distributions for different anchor points of an exposure curve.

It can be advantageous for the camera to comprise a wide-angle lens. Advantageously, such a camera can capture the intensity distribution that emerges from a large-area diffuser, without the camera having to be moved or a plurality of images having to be combined. The measuring method can be carried out particularly rapidly and reliably in conjunction with low energy consumption.

Preferably, the camera lens can be positioned centrally and plane-parallel with respect to the diffuser. In this way, the captured image of the intensity distribution can correspond directly to that of the master element. However, it can also be preferred—for example for reasons due to space in an exposure chamber—for the camera to be tilted eccentrically and/or in relation to the diffuser.

In such cases, it can be advantageous to input the directly captured intensity distribution into a processor configured for image correction, in order to reconstruct an intensity distribution as though it were viewed from a central and plane-parallel position.

In some embodiments of the invention, it can be preferred for the camera to be a black-and-white camera. In this regard, an image of the intensity distribution emerging from a diffuser can be created rapidly and with low data consumption. This could make it possible to increase the resolution of the captured intensity distribution. The captured intensity distribution can be processed rapidly in order to ascertain an optimized replication parameter. If the intention is to investigate the efficiency of the master element in the case of exposure with different wavelengths, the black-and-white camera can be used by way of the master element being exposed with the different wavelengths successively rather than simultaneously. The black-and-white camera is therefore a particularly flexibly usable type of detector.

In some embodiments of the invention, it can be preferred for the camera to be a full-colour camera, preferably an RGB camera. Such a camera can be used to capture the intensities of the different wavelengths which are transmitted by the master element or the diffuser. In particular, an RGB camera can be used to extract the intensity distribution of the different wavelengths from a single image if the master element is simultaneously exposed with light beams of different wavelengths. In particular, the different colour channels of a captured full-colour image can be isolated from one another by a processor. If the measuring method is used with an RGB camera in order to investigate the efficiency of the master element at different wavelengths, it is preferred for the different wavelengths to be sufficiently far apart from one another. For example, there can be at least 50 nm, in particular at least 100 nm, between two investigated wavelengths. The colour channels of an RGB camera are generally represented by overlapping sensitivity curves of the camera sensors for each wavelength range respectively corresponding to the red, green and blue parts of the spectrum. In the region of overlap, such cameras are possibly less effective in the context of recognizing the wavelength of the light. By virtue of the wavelengths used to test the master element being selected such that they are far enough apart from one another, they can come within the ranges with high sensitivity of the colour curves of the RGB camera, whereby the accuracy of the resulting analysis is improved.

The replication parameters ascertained by the measuring method can be specific to a certain wavelength, e.g. by the intensity of the respective light beam being increased or the wavelength thereof being shifted. The ascertained replication parameter can also apply generally to all investigated wavelengths, e.g. the increase in the intensity of all exposure beams.

In a second aspect, the invention relates to a replication method for the replication of a hologram from a master element into a light-sensitive material. The replication method is effected by way of applying at least one replication parameter which was defined by means of a measuring method as described above.

By ascertaining a replication parameter for a specific master element using the measuring method according to the invention, and by using this replication parameter when carrying out a replication method, it is possible to optimize the replication to the actual optical function of the master element. The production of the master element within certain manufacturing tolerances and the resulting deviations of the optical function from a target function can be compensated for on the basis of the data captured experimentally in the measuring method. This has proved to be significantly more precise and more reliable than the use of simulative methods for estimating the efficiency of a master hologram in conjunction with specific replication parameters. The replication method can be carried out significantly more efficiently and with a higher degree of repeatability. The replicated holograms produced have a higher quality. Since the replication parameters can be ascertained rapidly and efficiently by the measuring method, the replication method can be regularly updated so that it is always adapted to a current state of the master element.

Since the changeover from the measuring method to the replication method preferably involves only applying a light-sensitive material to the second side of the master element and removing the diffuser from the first side of the master element, the changeover can be accomplished rapidly. The measuring method can thus be carried out without a long production stoppage, or regularly. The replication method can be carried out over a long period of time, without the ageing master hologram having to be exchanged. A high replication efficiency is thus attained over a long period of time.

Within the meaning of the invention, a “light-sensitive material” is preferably a material which reacts to the exposure by a sufficiently coherent light source in such a way that an interference pattern arises in the volume of the material. Examples of such materials are silver halides, dichromated gelatin, photopolymers, photochromic materials and photothermoplastics. The light-sensitive material can be provided with a carrier film on at least one side in order to facilitate its handling. The light-sensitive material can also be present in a manner enclosed in carrier films. The carrier films are preferably transparent to the reference and object beams used for the exposure of the light-sensitive material.

It can be preferred for the light-sensitive material to be present in the form of a light-sensitive composite web comprising a photopolymer layer. Preferably, the photopolymer layer is enclosed between two transparent carrier films. The light-sensitive composite web can be supplied as a roll, such that the light-sensitive composite web, portion by portion, is laminated onto the master element, exposed and removed. It is thereby possible for the replication method to be carried out continuously.

A “composite” within the meaning of the invention is preferably a multilayered material consisting of two or more different components having different physical properties, which are bonded to one another at an interface. Preferably, the bond between the individual components is constituted such that it is not separable by slight force influence and is therefore deemed to be permanent. The composite can consist of a light-sensitive liquid, a solid or a resin, for example, which are enclosed between two transparent carrier films. Alternatively or additionally, the composite web can comprise a stack of layers that are each light-sensitive for different spectral ranges.

A “light-sensitive composite web” within the meaning of the invention is preferably a composite material having a length that is at least double, preferably at least five times, and even more preferably at least twenty times, its width. The thickness of the composite web is preferably set such that it has a certain flexibility, enabling it to be partly wound around a roller, for example. Preferably, the composite web has a thickness of up to 300 μm. The composite web comprises a light-sensitive material. Preferably, the composite web encloses the light-sensitive material between two transparent carrier films having a refractive index similar to that of the light-sensitive material. Preferably, the refractive index of the carrier films and of the light-sensitive material is between 1.4 and 1.6. The light-sensitive material can be for example a light-sensitive photopolymer or a dichromated gelatin. The light-sensitive material can be light-sensitive or wavelength-selective for the entire visible spectrum.

The exposure can preferably be effected using a coherent light source. Coherence preferably refers to the property of optical waves according to which there is a fixed phase relationship between two wave trains. As a result of the fixed phase relationship between the two wave trains, spatially stable interference patterns can arise. In terms of coherence, a distinction can be made between temporal and spatial coherence. Spatial coherence preferably represents a measure of a fixed phase relationship between wave trains perpendicular to the propagation and is given, for example, for parallel light beams. Temporal coherence preferably represents a fixed phase relationship between wave trains along the direction of propagation and is given in particular for narrowband, preferably monochromatic, light beams.

The coherence length preferably denotes a maximum path length difference or time-of-flight difference between two light beams from a starting point, in order that a (spatially and temporally) stable interference pattern still arises during their superposition. The coherence time preferably refers to the time that the light needs to travel a coherence length.

In preferred embodiments, the light source is a laser. Particularly preferably, the light source is a narrowband, preferably monochromatic, laser having a preferred wavelength in the infrared, visible and/or UV range (preferably 200 nm-25 μm, even more preferably 400 nm to 780 nm). Lasers preferably denote light sources which emit laser radiation. Non-exhaustive examples include solid-state lasers, preferably semiconductor lasers or laser diodes, gas lasers or dye lasers. Lasers can be selected such that they emit light of a specific wavelength or in a specific wavelength range. This can be achieved by selecting a laser composed of a suitable material. For example, it is possible to use ruby lasers, He—Ne lasers, Ar⁺ lasers, Kr⁺ lasers, He-Cd lasers and/or Nd³⁺:YAG lasers. These or other types of lasers can be combined with an optical parametric oscillator in order to generate coherent beams of different wavelengths. Lasers having different wavelengths can also be combined, e.g. in order to produce an RGB laser.

Different types of lasers, in particular solid-state lasers, can be combined with an optical parametric oscillator in order to generate coherent beams of different wavelengths as a tunable system. The optical parametric oscillator preferably comprises an optical resonator and at least one nonlinear optical crystal. Preferably, in particular systems having a multiplicity of converter crystals can be used, with three-wave mixing (f_pump=f_signal+f_idler) being used. By altering the frequency f_signal and/or f_idler, it is possible to generate laser wavelengths in a very wide wavelength range. This encompasses in particular the entire visible range and the infrared range of the electromagnetic spectrum.

Other light sources, preferably coherent light sources, can also be used. Preference is given to narrowband light sources, preferably monochromatic light sources, including, for example, light-emitting diodes (LEDs), optionally in combination with monochromators.

The coherence of the light beams is of relatively little relevance to the generation of relief holograms. Particularly for the replication of volume holograms, by contrast, it is preferred for the light source used for replication to be sufficiently coherent.

Preferably, a volume hologram is written into the composite web by replication of the master hologram. A sequence of Bragg planes preferably arises as a result of the interference of object and reference beams within the hologram volume. Consequently, a volume hologram preferably has a non-negligible extent in the propagation direction of the light beams, with the Bragg condition applying in the case of the reconstruction at a volume hologram. It is for this reason that volume holograms advantageously have a wavelength and/or angle selectivity.

In preferred embodiments of the invention, the coherence length of the light source is with preference at least 150 μm, more preferably at least 500 μm, and even more preferably at least 2 mm. Preferably, the coherence length is at least twice the distance between the light-sensitive material and the master hologram. With preference, however, the coherence length is also not so long that parasitic microstructures, such as e.g. disturbing gratings, occur in the hologram. The maximum preferred coherence depends on the hologram type and the geometric dimensions of the exposure module. In preferred embodiments, the coherence length of the light source is less than 1 m.

The light source can comprise a plurality of light sources. The latter can preferably be configured such that they scan a line or a region of the photopolymer composite in optical contact with the master element.

The steps of hologram production that succeed exposure can be as known. For example, the exposed light-sensitive composite web can be cured using a UV light emitter. This can take place in a chamber separate from the exposure. The exposed and cured composite web can then be cut into individual holograms, rolled up or processed further in some other way.

In a further preferred embodiment of the invention, the at least one replication parameter relates to an exposure intensity with which the master element is exposed during the replication. Since local or general efficiency losses occur on account of the manufacturing method and/or ageing of the master element, the use of the exposure intensity defined in the measuring method for the replication can compensate for this efficiency loss. In this way, the master element can still be used for the replication, and in the process maintaining almost a replication quality that would be achieved with an ideal master element.

Preferably, the intensity for different positions on the master element is defined on the basis of the captured intensity distribution. Not only a general but also a localized deviation of the master element from a target function can be compensated for in this way. The replication method can thus be carried out even for non-uniformly deformed master elements with high quality.

In a further preferred embodiment of the invention, the at least one replication parameter relates to an exposure point from which the master element is exposed, preferably in order to maximize an efficiency of the master element during the replication. As explained above, the process for manufacturing the master element may alter the function of its interference pattern relative to a theoretical function. As standard practice, the master element is exposed with parameters which are exactly coordinated with the theoretical function. Since the real master element has a different optical function from the theoretical function, it is expedient to adapt the exposure parameters as well. The latter can include in particular the position of an exposure point.

By carrying out the replication with an exposure point ascertained by the measuring method, the efficiency of the replication can be improved. For example, the exposure point chosen by the measuring method can cause a larger proportion of the reference beam to be diffracted in the first order in order to form the object beam. This can involve, as explained above, an optimized exposure point for the exposure of the entire master element. Likewise, the exposure point can be a point on an exposure curve which can be adjusted on the basis of the results of the measuring method in order to adapt the exposure curve to the actual properties of the master element.

In a further preferred embodiment of the invention, the at least one replication parameter relates to a wavelength, in the measuring method intensity distributions for two or more wavelengths being captured and the wavelength used during the replication preferably being selected in order to maximize an efficiency of the master element during the replication.

Capturing intensity distributions at at least two different wavelengths enables the influence of the wavelength on the efficiency of the master element to be determined experimentally. This can be particularly useful if shrinkage or swelling changes the wavelength of the interference pattern stored in the volume of the master hologram. If the wavelength for the exposure is selected on the basis of a multiplicity of investigated wavelengths, the replication method can be carried out for example with a wavelength preferably tested previously in the measuring method or with a wavelength which was calculated by interpolation or extrapolation from tested wavelengths. The replication method can thus be carried out with higher efficiency, and ensure holograms of extremely high quality.

A single optimized wavelength can be selected for the exposure of the entire master element. However, it can be preferred for a plurality of wavelengths defined by the measuring method to be used for a plurality of corresponding points or regions of an exposure curve, e.g. with the aid of a tunable laser.

In a further preferred embodiment of the invention, the replication method comprises the exposure of the light-sensitive material and of the master element by moving an exposure point along an exposure curve, the exposure curve preferably comprising a plurality of anchor points, and for each individual anchor point and/or for the entire exposure curve a replication parameter defined by the measuring method is applied during the exposure in order preferably to maximize an efficiency of the master element during the replication.

It can also be advantageous for a replication parameter determined by the measuring method to be used for only one anchor point. The other anchor points can still be replicated with target parameters and the rest of the exposure curve can be calculated anew. It can also be preferred for a replication parameter determined by the measuring method to be used only for some of the anchor points, while other anchor points are replicated with target parameters. The exposure curve can correspondingly be calculated anew.

By virtue of the replication of a master hologram with an exposure curve, different regions of the replicated hologram can have different optical properties. The latter can be closely matched to the properties of the master hologram. For example, different regions of the replicated hologram can have different reconstruction angles. This can be useful for example for holograms which are incorporated into curved surfaces such as e.g. automotive interiors.

By adapting the replication parameters for one or a plurality of individual anchor points of the exposure curve, it is possible to compensate for regional inefficiencies in the master element. The transition to the parameters of adjacent anchor points can be effected seamlessly, such that the regional adaptation is not noticeable in the replication hologram. The resulting holograms can be produced with high quality and the same master element can be reused for a longer time without being exchanged.

The application of a single replication parameter or a single mathematical adaptation function to all points of the exposure curve can be advantageous if the intensity distributions captured in the measuring method indicate an inefficiency that relates equally to all regions of the master element. For example, the wavelength of all anchor points can be changed to a new wavelength ascertained by the measuring method. In this case, the replication parameter is a wavelength. It can also be advantageous to shift or tilt the entire exposure curve in order to maintain the same relative distances between the anchor points. This can be preferred if the replication parameter is an intensity or an exposure angle. It is also possible to combine these approaches, e.g. by changing the wavelength of all anchor points and shifting the exposure curve. Further examples of such adaptations are set out with regard to the measuring method and can be used in the replication method as well.

In a further preferred embodiment of the invention, moving the exposure point comprises a change in its position and/or in an angle of its beam path, the exposure point preferably being moved by means of a controlled positioning module.

Preferably, the positioning module comprises one or more actuators in order to move an exposure point at least in a plane parallel to the master hologram. Preferably, the positioning module also comprises one or more actuators in order to move the exposure point in a plane that traverses the master hologram, i.e. in order to bring the exposure point closer to the master hologram or move it away from the latter. In this case, the light source (e.g. the laser) can also be moved by the positioning module or be arranged separately from the latter. Preferably, the positioning module comprises a robotic arm having one or more adjustable axes and having one or more actuators. Alternatively, the positioning module could comprise a multi-axis optical linear adjustment table. Preferably, the adjustment table also has at least one rotational degree of freedom.

The positioning module preferably also comprises an optical component which can bring about beam deflection. Preferably, the optical component is arranged in a tiltable fashion, such that an inclination of the optical component can change an angle of the beam path. The optical component can be configured such that it can be tilted in a single plane, in two planes or in all three planes. The optical component preferably comprises a lens element, a mirror and/or a prism.

The optical component can be a mirror, for example. The mirror can be tilted stepwise with the aid of a motorized joint. This can lead to a corresponding tilting of the reference beam that reaches the master element. In this case, the exposure point can be a point on the mirror.

The movement of the positioning module and/or of the optical components can be controlled by a control unit.

In a further preferred embodiment of the invention, the light-sensitive material and a second side of the master element are exposed with light in a plurality of steps, while a first side of the master element situated opposite the second side faces a detector and the detector captures the intensity distribution of the light emerging from the first side of the master element during the exposure. Preferably, in a later step of the exposure the replication parameter defined in the measuring method is adapted on the basis of the intensity distribution captured in an earlier step of the exposure.

Within the meaning of the invention, an earlier step and a later step of the exposure can each be steps for the replication of a single copy, a plurality of successive copies or a plurality of non-successive copies of a master hologram.

Such an embodiment of the invention leads to particularly good results in the replication process, since possible alterations of the master hologram during the replication can be reliably captured and taken into account. Moreover, the method advantageously does not necessitate interruption of a continuous replication method. Since the exposure of the master element and the capture of an intensity distribution are effected on different sides of the master element, they can be carried out simultaneously and need not conflict with one another. Since the master hologram is a reflection hologram, the object beam is reflected by the interference pattern of the master hologram, without emerging from the first side of the master element. Therefore, during the replication method, the detector can remain on the first side of the master element in the same position as in the measuring method.

Instead of being scattered by a diffuser that is preferably removed from the first side of the master element during the replication process, a reference beam can instead be partly scattered by the light-sensitive material (for example in the light-sensitive composite). In this embodiment, the light-sensitive material itself can function as the above-described diffuser for the measuring method. During the replication of a master hologram using a result of the measuring method, which was ascertained with the diffuser as described above, this embodiment enables further fine-tuning of the replication parameters, in particular in the continuous replication method.

This can exploit the fact that unexposed material causes greater scattering than exposed material. Scattered light from the superposition of the 1st order and a reference beam can thus be captured by a detector. In this case, the intensity of the light scattered in the light-sensitive material correlates with the proportion of the 1st order, which can prove to be of varying magnitude depending on the efficiency of the master. The light emerging from the first side of the master element is preferably captured by the detector in order to provide conclusions about the state, in particular of the efficiency of the master element. In this way, the replication parameter ascertained by the measuring method can additionally be subsequently controlled during the replication method. A very fine-tuned adaptation of the replication parameters to the actual properties of the master element can be achieved as a result.

Without a separate diffuser, it cannot reliably be ensured that the emerging light of the zero, undiffracted order can be captured by the detector from a multiplicity of angles. Depending on the emergence angle, the emerging light of the zero, undiffracted order may instead propagate past the detector. Instead of the zero order, the detector for establishing the efficiency of the master hologram can however advantageously capture scattered light resulting from the first order of diffraction that is reflected into the material to be exposed. There may be a kind of phosphorescence here. In this regard, the light which is reflected by the master element (1st order) can be at least partly scattered into as yet unexposed regions of the light-sensitive material. This scattered light advantageously emerges from the light-sensitive material in a wide angular range and can therefore be reliably captured by a detector, such as e.g. a camera, in order to record a light intensity distribution.

In this embodiment, bright regions of the light intensity distribution (high light intensity) preferably indicate a high efficiency of the master hologram since the scattered light correlates positively with the light reflected into the first order by the master element.

Darker regions preferably indicate a smaller proportion of a reflection into the first order and hence a lower efficiency of the master hologram. Consequently, when capturing the first-order scattering in the replication method, the ratio between brightness and efficiency is the inverse of that in the embodiments of the measuring method in which a diffuser is used in order to scatter 0 order diffracted light and capture it by means of a detector.

In this embodiment, it can be advantageous for the master element to be exposed with an exposure curve over a large area or step by step. If the master element is exposed over a large area, an intensity distribution for the entire master element can be taken during an earlier exposure step. A replication parameter for the entire master element can be subsequently controlled on this basis. This replication parameter can be applied e.g. during the production of a subsequent copy of the master hologram in a continuous method.

By contrast, if the master element is exposed with an exposure curve step by step, it is possible to capture an intensity distribution for at least one anchor point. That could be used to draw conclusions about the state of the entire master element and the entire exposure curve can be correspondingly adapted.

However, it can be preferred to capture a respective intensity distribution for one or more, preferably all, anchor points of the exposure curve. In the course of subsequently implementing the exposure of the master hologram, a replication parameter for the respective anchor points can be subsequently controlled on this basis. The exposure process can thus be continuously calibrated and adapted to the optical properties of the master element. In this regard, the replication method is efficient over a long period of time.

Terms such as substantially, approximately, about, circa, etc., preferably describe a tolerance range of less than ±20%, preferably less than ±10%, particularly preferably less than ±5%, and in particular less than ±1%, and include the exact value.

The person of average skill in the art recognizes that technical features, definitions and advantages of preferred embodiments of the measuring methods according to the invention also apply to the replication method according to the invention, and vice versa.

### DETAILED DESCRIPTION

The invention will be explained in more detail below by means of examples and figures, without being limited thereto.

### BRIEF DESCRIPTION OF THE FIGURES

FIG. 1 is a schematic illustration of an ideal planar reflection master hologram that is exposed from an exposure point.

FIG. 2 is a schematic illustration of an actual (non-ideal) reflection master hologram in a master element. The exposure from a target exposure point and from an exposure point ascertained by the measuring method is shown schematically.

FIG. 3 is a schematic illustration of a measuring method in accordance with one preferred embodiment of the invention, a diffuser and a detector being present arranged on a first side of the master element.

FIG. 4 is a schematic illustration of a measuring method in accordance with one preferred embodiment of the invention, an intensity distribution being captured in each case at a first exposure point and a second exposure point.

FIG. 5 is a schematic illustration of an intensity distribution upon exposure of the master element from a first exposure point.

FIG. 6 is a schematic illustration of an intensity distribution upon exposure of the master element from the second exposure point.

FIG. 7 is a schematic illustration of a measuring method in accordance with a further preferred embodiment of the invention, an intensity distribution being captured for a plurality of anchor points of an exposure points and a shift of the exposure curve being effected.

FIG. 8 is a schematic illustration of a positioning module for the movement of an exposure point over an exposure curve.

FIG. 9 is a schematic illustration of a positioning module according to an alternative embodiment for the movement of an exposure point over an exposure curve, the positioning module comprising a robotic arm.

FIG. 10 is a schematic illustration of a replication method in accordance with a further preferred embodiment of the invention, a light-sensitive material scattering the reference beam and the scattered light being captured as an intensity distribution. On the basis of the intensity distribution, a replication parameter is subsequently controlled in-line.

### DETAILED DESCRIPTION OF THE FIGURES

FIG. 1 shows an ideal reflection master hologram 4 as a horizontal dashed line. The master hologram 4 has an optical function that corresponds exactly to its theoretical (or target) optical function. That is to say that the master hologram 4 preferably has a uniform thickness and has in its volume an interference pattern that corresponds exactly to the interference pattern which was recorded in a computer-implemented programme for the hologram mastering. FIG. 1 shows the master hologram 4, which is exposed by a reference beam 16 emanating from a target exposure point 14. The reference beam 16 can have a predetermined wavelength. A point light source can be provided at the target exposure point 14, and so the master element is illuminated over a large area. Proceeding from the target exposure point 14, the reference beam 16 approaches the master hologram 4 at a predefined angle. Since the master hologram 4 has not experienced a deformation or degradation as a result of its production or as a result of processing steps of integration into a master element and has a maximum efficiency, the reference beam 16 is completely reflected by the master hologram 4 in order to generate the object beam 18 having a predefined angle with respect to the master hologram 4.

The position of the target exposure point 14 relative to the master hologram 4, the predefined wavelength and/or the angle at which the target reference beam16 approaches the master hologram 4 can be stored beforehand as standard replication parameters for the copying of the master hologram 4. The standard replication parameters stored beforehand can serve as instructions for the exposure of the master hologram 4 during a replication method. As will be explained below, however, the standard replication parameters lead to the highest possible replication efficiency only if the optical properties of the master hologram 4 actually correspond to the theoretical optical properties thereof. If the optical properties of the master hologram 4 begin to deviate from the target properties, it can be advantageous to expose the master hologram with correspondingly adapted replication parameters.

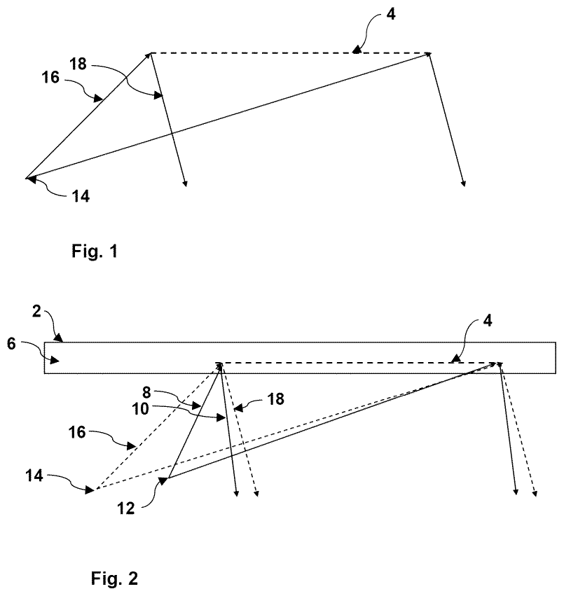

FIG. 2 shows a master hologram 4 embedded into a transparent substrate body 6. The master hologram 4 and the substrate body 6 together form a master element 2. Such a master element 2 is thicker than the master hologram 4 by a multiple and is therefore significantly more robust and much simpler to handle in practice. However, the process of creating the master hologram 4, its integration into the master element 2 and its storage or use over the course of time can lead to alterations of its optical properties.

These changes can have the effect that the target exposure parameters for the exposure of the master hologram 4 are no longer the most effective exposure parameters. The target exposure point 14, the target reference beam 16 and the target object beam 18 are represented as dashed lines in FIG. 2. Since the assumptions taken as a basis for the determination of these target exposure parameters do not take account of the current properties of the master element 2, the target reference beam 16 is possibly not completely reflected by the master hologram 4. The intensity of the generated object beam may therefore be too low to generate the desired interference in the light-sensitive material. A high-quality copy of the master hologram cannot be created with these replication parameters.

Instead, for this purpose it is necessary for the master hologram 4 to be exposed with a different, optimized exposure point 12, the position of which is shifted in relation to the target exposure point 14. The light source used can also have a different wavelength from the target wavelength. An optimized reference beam 8 can be incident on the master element 2 at a different angle and/or with a different wavelength, which leads to better compliance with the requirements of the interference pattern of the master hologram 4 integrated into the master element. The reference beam 8 can be reflected with a higher efficiency in order to form the object beam 10. This is illustrated schematically by solid lines. The sufficiently intensive object beam 10 can then interfere with the reference beam 8 in the light-sensitive material in order to form the desired interference pattern. The quality of the copied master hologram can thus be improved and the master hologram can continue to be used.

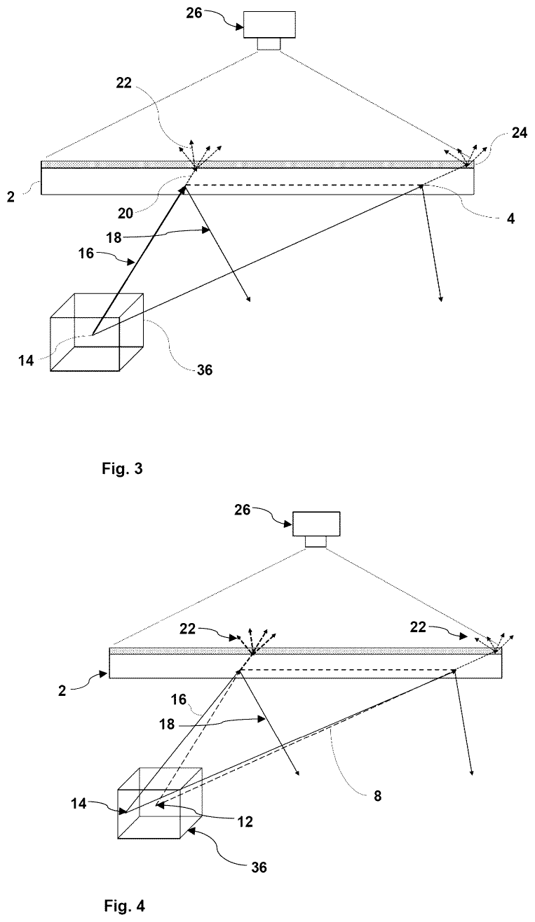

FIG. 3 schematically shows a measuring method in accordance with one preferred embodiment of the invention. A master element 2 is provided between a first exposure point 14 and a detector 26, in this case a camera. The top side of the master element 2 is referred to as the first side and the underside of the master element 2 is referred to as the second side. A diffuser 24 is situated between the master element 2 and the detector 26. Although direct contact is not required for carrying out the invention, the diffuser in this embodiment is in direct contact with the first side of the master element 2.

If the master element 2 is exposed from the first exposure point 14, a first reference beam 16 is incident on the second surface of the master element 2 at a predefined angle. Since the master hologram 4 has experienced alterations as a result of its production, integration into a master element, use or storage, the first reference beam 16 is only partly reflected by the master hologram 4 and forms the first object beam 18. A portion of the light of the first reference beam 16 is guided through the master hologram 4, through the substrate body 6 and then into the diffuser 24. The diffuser 24 scatters the light of the reference beam in order to form the scattered radiation 22, which preferably radiates in all directions of a hemisphere on the top side of the diffuser 24.

On account of the scattering of the light radiated from the top side of the diffuser 24, the detector 26, with a sufficient lens angle, can measure the intensity of the light radiated from all regions of the diffuser. That is to say that the scattered light 22, which can be seen on the left and right in the schematic drawing, can be captured equally by the detector 26 even though these regions are situated at different angles with respect to the detector 26.

By capturing the intensity distribution during the exposure of the master element 2 with the first exposure parameters, it is possible to establish whether the first exposure parameters match the actual optical function of the master hologram 4 and, if not, in what regions and to what extent the exposure parameters are in need of improvement. In the case of an ideal master hologram 4 designed for complete reflection of the reference beam, no light would emerge from the diffuser and the detector would register a black image. On the basis of the captured intensity distribution, it is possible to carry out an exposure with the first exposure parameters or with generally or locally optimized new exposure parameters. For the sake of better elucidation, FIG. 3 also shows a theoretical exposure volume 36, within which an exposure point can be selected, in particular for the entire master hologram or a region thereof.

FIG. 4 schematically shows a change in the regional efficiency of the master hologram 4 if a different second exposure point 12 within the theoretical exposure volume 36 is selected in order to expose the master element 2 over a large area. The first reference beam 16 and the first object beam 18 resulting therefrom are illustrated using solid lines for comparison. The new second reference beam 8 and the resulting scattered light 22 transmitted by the diffuser 24 are illustrated by dashed lines. As indicated by the thicker dashed lines in the region of the scattered light radiated from the left-hand part of the diffuser 24, the second exposure point 12 leads to a higher intensity of the light for this region of the diffuser. This indicates a poorer efficiency of the exposure in the corresponding region of the master hologram. On the other hand, the scattered light 22 radiated from the right-hand region of the diffuser 24 has a lower intensity indicated by the thinner dashed lines. For this region, the second exposure point 12 can lead to an angle of incidence of the second reference beam 8 which is better coordinated with the actual properties of the master hologram 4. This information can be used when selecting the exposure point or radiation angle for the entire master hologram or for specific regions or points thereof. This information is supplied in particular in the form of an intensity distribution for each tested exposure point 14, 12 before one or more replication parameters are derived from the results.

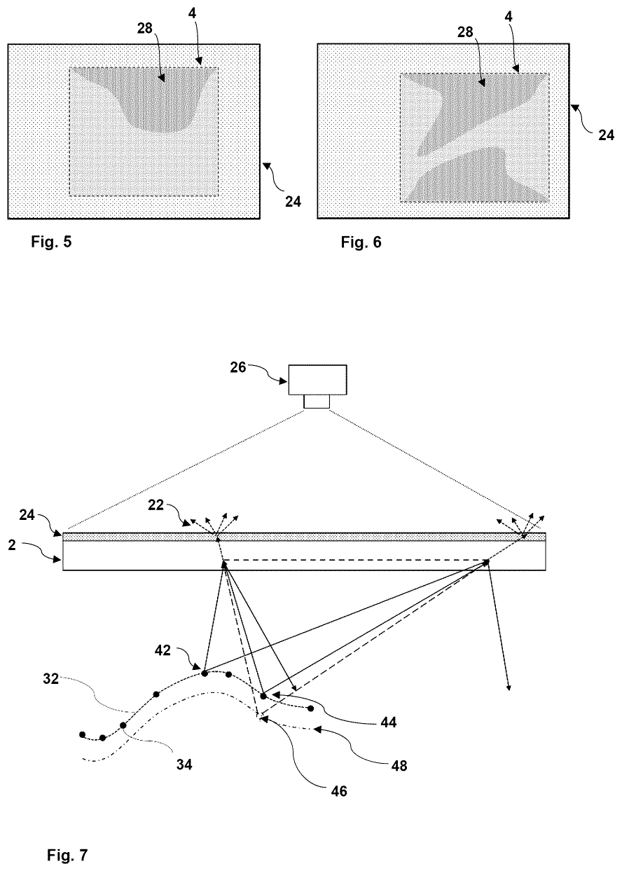

FIGS. 5 and 6 schematically show the intensity distributions 28 captured for the same master hologram 4 when it is exposed from two different exposure points (for example from the first exposure point 14 and the second exposure point 12). As can be discerned, the intensity distributions vary, the intensity distribution in FIG. 6 having overall a larger dark region. Since the dark regions indicate a high efficiency, the exposure point from FIG. 6 can be deemed to be more suitable. The same exposure point can be selected for a replication method. Alternatively, a third exposure point can be selected on the basis of a trend evident from the results for the two tested exposure points. On the basis of the captured intensity distributions, further exposure points can also be selected and tested, preferably by means of an iterative process that converges to a maximum exposure efficiency.

FIG. 7 shows an embodiment of a measuring method in which the master hologram 4 is intended to be replicated with the aid of an exposure curve 32. In this embodiment, the entire master hologram 4 is not exposed over a large area by a single exposure point, rather the master hologram 4 is exposed in sections. Each section of the master hologram 4 is assigned a section of an exposure curve for the exposure. In other words, a plurality of exposure point positions are used for a master hologram 4.

This can be achieved for example by moving at least one exposure point (e.g. a point on a mirror) along an exposure curve 32. The exposure curve 32 is preferably configured such that it progresses through a discrete number of anchor points 34 each having predetermined target replication parameters. The exposure curve 32 preferably offers a smooth spatial transition between the anchor points 34. Preferably, the exposure curve 32 also ensures a fluid transition between the exposure parameters of the anchor points 34, such as e.g. wavelength or intensity.

FIG. 7 furthermore shows the target reference beams and the resulting object beams from the fifth anchor point 42 and the seventh anchor point 44 (from left to right) with the aid of solid lines. As illustrated by the dashed arrows 22, a portion of the light upstream of the seventh anchor point 44 is not completely reflected by the master hologram 4 and instead is transmitted and scattered by the diffuser 24. The replication parameters of at least this anchor point 44 are therefore not optimally adapted to the actual properties of the master hologram 4. Here it is possible to investigate the intensity distribution and therefore the efficiency of the master hologram in the case of an alternative seventh anchor point 46. The position of the alternative seventh anchor point 46 may differ from the target position. The reference beams originating from the alternative seventh anchor point 46 are illustrated by dashed lines. The dashed lines schematically show that the angles of incidence of the new reference beams on the master element 2 are different from the target angles.

If it transpires that the alternative seventh anchor point 46 enables a more efficient exposure of the master hologram, the entire exposure curve can be correspondingly shifted. This is illustrated schematically by the dashed curve 48 in FIG. 7. Alternatively, the exposure curve can also be calculated anew such that it progresses through the new seventh anchor point 46 instead of the original seventh anchor point 46. Preferably, each anchor point 34 is tested by the measuring method and a new replication parameter (in particular a relative position with respect to the master element 2) is ascertained for each point. Afterwards, a new exposure curve 48 can be calculated.

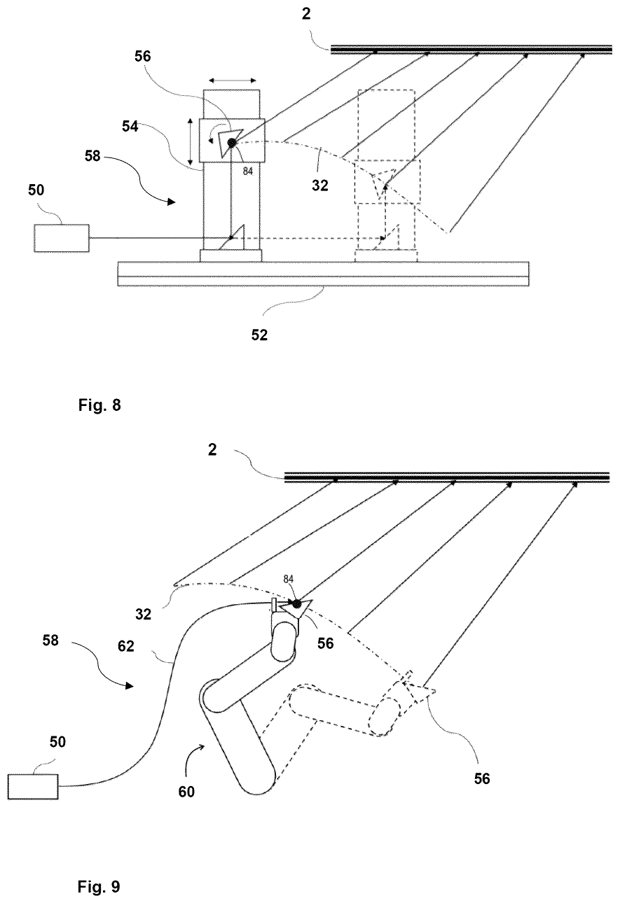

The implementation and adjustment of the exposure curve 32 will be explained in greater detail with reference to FIG. 8. FIG. 8 schematically shows a master element 2 arranged above a positioning module 58. The positioning module 58 is configured such that it moves an exposure point 84 along the exposure curve 32 for the measuring method and/or for the replication method. In this example, the exposure point 84 is a point on a tiltable scanning mirror 56 from which a reference beam 8 is directed onto the master element 2. A light source 50, in this case a laser, emits a light beam that is guided through a series of optical elements (in this case a periscope arrangement) to the exposure point 84. The light source 50 is preferably positionally fixed. Optionally, the light source 50 can be configured such that it scans along a single linear path in a single horizontal plane.

In order to move the exposure point 84 along the exposure curve 32, the scanning mirror 56 is positioned on the positioning module 58. The positioning module 58 comprises a horizontal adjustment table 52 and a vertical adjustment table 54. The horizontal adjustment table 52 brings about a horizontal component of a movement of the exposure point 84, while the vertical adjustment table 54 brings about a vertical component thereof. In addition, the angle of the reference beam 8 is preferably adjusted by tilting the scanning mirror 56, preferably with the aid of a motor. The sequence of the vertical, horizontal and tilting movements required to move the exposure point 84 over the exposure curve 32 is preferably stored beforehand and/or calculated by a processor. However, the exposure curve 32 can be continuously evaluated and calculated anew.

FIG. 9 shows an alternative embodiment of the positioning module 58, an exposure point 84 being moved along an exposure curve 32 with the aid of a robotic arm 60. In this embodiment, an optical fibre delivers coherent light from the light source 50 to a scanning mirror 56. Actuators in the robotic arm 60 move the scanning mirror 56 along the exposure curve 32 and simultaneously tilt it in order to direct light beams at the master element 2 from different angles. Such a robotic arm can precisely expose the master element 2 with a multiplicity of different exposure curves, including linear, curved and freeform exposure curves.

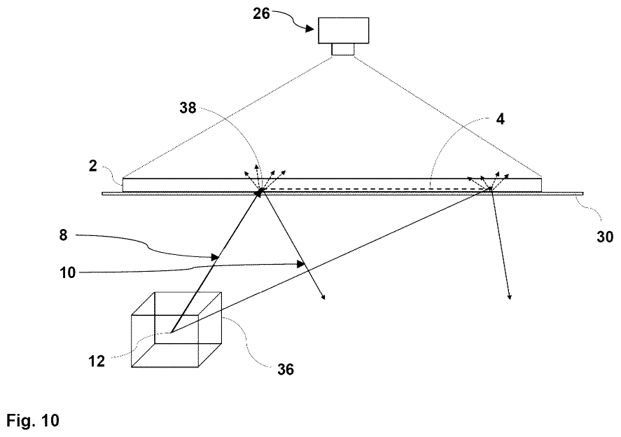

FIG. 10 schematically shows one preferred embodiment of the replication method in which the exposure parameters are subsequently controlled in-line. In this case, the diffuser is removed in order to avoid unwanted interference with the replication method. The scattering properties of the light-sensitive material 30 into which the hologram is replicated are utilized instead. The master hologram 4 is exposed from a predetermined exposure point 12. The reference beams 8 emanating from the exposure point 12 are incident on the light-sensitive material 30 and the master element 2 at predefined angles. The reference beam 8 is partly reflected by the interference patterns in the master hologram 4 in order to generate the object beam 10. The object beam 10 interferes with the reference beam 8 and forms a corresponding interference pattern in the light-sensitive material 30.

At the same time, a detector 26 can capture scattered light from a superposition of the reference beam 8 and the first-order diffracted light 38. The capture of the intensity distribution is facilitated by the fact that unexposed light-sensitive material causes greater scattering than exposed material. In this case, the intensity of the light scattered in the light-sensitive material correlates with the proportion of the diffracted 1st order, which can prove to be of varying magnitude depending on the efficiency of the master. In this embodiment, bright regions of the light intensity distribution preferably indicate a high efficiency of the master hologram 4 since the scattered light correlates positively with the light reflected into the first order by the master hologram 4. By contrast, darker regions indicate a smaller proportion of a reflection into the first order and hence a lower efficiency of the master hologram. The captured light intensities can thus be used to assess the local efficiencies of the master hologram 4. This information can influence later steps and/or later passes of the replication method in order to improve the efficiency by adapting the replication parameters.

### LIST OF REFERENCE SIGNS

2 Master element
4 Master hologram
6 Substrate body
8 Reference beam
10 Object beam
12 Exposure point
14 Target exposure point/First exposure point
16 Target reference beam/First reference beam
18 Target object beam/First object beam
20 0 order diffracted reference beam
22 0 order scattered reference beam
24 Diffuser
26 Detector
28 Intensity distribution
30 Light-sensitive material
32 Exposure curve
34 Anchor point
36 Exposure volume around exposure point or anchor point of the exposure curve
38 First-order reference beam scattered by the light-sensitive material
42 Fifth anchor point in FIG. 7
44 Seventh anchor point in FIG. 7
46 Alternative seventh anchor point in FIG. 7
48 Alternative exposure curve
50 Light source, in particular laser
52 Horizontal adjustment table
54 Vertical adjustment table
58 Positioning module
60 Robotic arm
62 Optical fibre
84 Exposure point on scanning mirror

1. A measuring method for defining at least one replication parameter for a replication method using a master element,
the measuring method comprising:
providing a master element comprising a reflection hologram, a light source, a detector and a diffuser, the diffuser being present positioned between the master element and the detector,
irradiating the master element with light from the light source
capturing an intensity distribution of the light emerging from the diffuser with the detector, and
defining at least one replication parameter on the basis of the captured intensity distribution.

2. The measuring method according to claim 1, wherein:
higher values of the intensity distribution indicate a lower efficiency of the master element in a replication method and defining the replication parameter is effected with regard to maximizing the efficiency of the master element in a replication method and/or reducing the deviation of the efficiency from a target value.

3. The measuring method according to claim 1, wherein:
irradiating the master element with light is performed using at least two different exposure parameters and defining the at least one replication parameter is effected on the basis of at least two intensity distributions which were captured for the at least two different exposure parameters.

4. The measuring method according to claim 1, wherein:
the at least one replication parameter corresponds to an exposure intensity, a wavelength, an exposure point and/or an angle of the beam path of the light at the exposure point.

5. Measuring The measuring method according to claim 1, wherein:
the at least one exposure parameter is an exposure point, capturing an intensity distribution of the light emerging from the diffuser being effected for at least two different exposure points.

6. The measuring method according to claim 5, wherein:
capturing an intensity distribution of the light emerging from the diffuser is repeated for at least three exposure points, the third and further exposure points being selected by an iterative process on the basis of the already captured intensity distributions in order to converge to an exposure point at which a maximum efficiency of the master element for a replication method should be expected.

7. The measuring method according to claim 1, wherein:
capturing an intensity distribution is effected for a multiplicity of spatially distributed anchor points of an exposure curve, defining the at least one replication parameter relating to a shift of the exposure curve and/or a variation of the anchor points.

8. The measuring method according to claim 1, wherein:
a control pattern for the intensity distribution is provided by capturing an intensity distribution for an isolated diffuser, the control pattern being taken into account when ascertaining the at least one replication parameter on the basis of the captured intensity distribution.

9. The measuring method according to claim 1, wherein:
the diffuser is a transmissive diffuser and behaves substantially like a Lambertian emitter.

10. Measuring The measuring method according to claim 1, wherein:
the detector is a camera, which captures the intensity distribution as a two-dimensional image representation of the surface of the diffuser.

11. A replication method for the replication of a hologram from a master element into a light-sensitive material, wherein:
the replication method is effected by way of applying at least one replication parameter which was defined by the measuring method according to claim 1.

12. The replication method according to claim 11, wherein:
the at least one replication parameter relates to an exposure intensity with which the master element (2) is exposed during the replication, the intensity for different positions on the master element (2) being defined on the basis of the captured intensity distribution

13. The replication method according to claim 11, wherein:
the at least one replication parameter relates to an exposure point from which the master element is exposed.

14. The replication method according to claim 11, wherein
the at least one replication parameter relates to a wavelength, in the measuring method intensity distributions for two or more wavelengths being captured and the wavelength used during the replication being selected in order to maximize an efficiency of the master element during the replication.

15. The replication method according to claim 11, wherein:
the replication method comprises the exposure of the light-sensitive material and of the master element by moving an exposure point along an exposure curve.

16. The replication method according to claim 15, wherein:
moving the exposure point comprises a change in its position and/or in an angle of its beam path.

17. The replication method according to claim 11, wherein
the light-sensitive material and a second side of the master element are exposed with light in a plurality of steps, while a first side of the master element situated opposite the second side faces a detector and the detector captures the intensity distribution of the light emerging from the first side of the master element during the exposure.

18. The replication method according to claim 15, wherein the exposure curve comprises a plurality of anchor points, and for each individual anchor point or for the entire exposure curve, a replication parameter defined by the measuring method is applied during the exposure in order to maximize an efficiency of the master element during the replication.

19. The replication method according to claim 16, wherein the exposure point is moved with a controlled positioning module.

20. The replication method according to claim 17, wherein in a later step of the exposure, the replication parameter defined in the measuring method, is adapted on the basis of the intensity distribution captured in an earlier step of the exposure.
